(19) United States
(12) Patent Application Publication
(10) Pub. No.: US 2014/0253574 A1
(43) Pub. Date: Sep. 11, 2014

(54) Development Environment For Capture Of Image Data From A Mobile Device

(71) Applicant: RESEARCH IN MOTION LIMITED, Waterloo (CA)

(72) Inventors: Michael Stephen Brown, Kitchener (CA); Terrill Mark Dent, Waterloo (CA); Kalu Onuka Kalu, Ottawa (CA)

(73) Assignee: RESEARCH IN MOTION LIMITED, Waterloo (CA)

(21) Appl. No.: 13/785,093

(22) Filed: Mar. 5, 2013

(51) Int. Cl. G06T 1/00

(52) U.S. Cl. CPC G06T 1/0007
USPC 345/545

(57) ABSTRACT

A method and device for acquiring an image such as a splash screen for an application. A screenshot instruction is sent to a target device upon detecting a trigger event; image data is received from the target device in response to the screenshot instruction; and upon receiving the image data, the image data is automatically stored and associated with the application.

### TECHNICAL FIELD

The present disclosure relates to integrated development environments, and particularly to a Web-based integrated development environment and graphical user interface for real-time collaborative application development, and more particularly to a development environment that facilitates the acquisition of image data from mobile electronic devices.

### BACKGROUND

Integrated development environments (IDEs) provide an interface through which developers can author, modify, compile and deploy software. With the growth of application development for mobile devices, there remains a need for improved methods and devices for developing software in an IDE.

### BRIEF DESCRIPTION OF THE DRAWINGS

FIG. 1 is a block diagram illustrating a network environment including a computer and a mobile communication device for interacting in accordance with example embodiments of the present disclosure.

FIG. 2 is a block diagram illustrating a computer or computer suitable for executing an application development tool in accordance with example embodiments of the present disclosure.

FIG. 3 is a block diagram illustrating a mobile communication device suitable for interacting with a computer operating an application development tool in accordance with example embodiments of the present disclosure and for operating as a device under test.

FIG. 4 illustrates an application running in the foreground and the same application running in the background.

FIG. 5A illustrates changes in the operational state when an application does not have permission to run in the background and is not visible.

FIG. 5B illustrates changes in the operational state when an application has permission to run in the background and is not visible.

FIG. 6 is a block diagram illustrating the inheritance chain associated with the Button control for the purpose of illustration.

FIG. 7 is a block diagram illustrating a scene graph for the Button control for the purpose of illustration.

FIG. 8 is an example editor user interface screen of the application development tool for creating, editing and viewing an application page in accordance with an example embodiment of the present disclosure.

FIGS. 9A to 9D show a Metadata user interface screen of the application development tool for setting application properties in accordance with an example embodiment of the present disclosure.

FIG. 10 is a Specification user interface screen of the application development tool in accordance with an example embodiment of the present disclosure.

FIGS. 11A and 11B show an Image user interface screen of the application development tool in accordance with an example embodiment of the present disclosure.

FIGS. 12A and 12B show a Showcase user interface screen of the application development tool in accordance with an example embodiment of the present disclosure.

FIG. 13 is an example Metadata user interface screen of the application development tool for setting application properties in accordance with example embodiment of the present disclosure.

FIG. 14 is a flow diagram illustrating an example embodiment of setting of images used by an application by acquiring screenshots from a target mobile communication device.

FIGS. 15 and 16 are flowcharts illustrating the actions taken by an application development server and a target mobile communication device, respectively according to example embodiments.

FIG. 17 is a flow diagram illustrating a further example embodiment for setting images used by an application by acquiring screenshots from a target mobile communication device.

### DETAILED DESCRIPTION

Reference will now be made to the accompanying drawings which show example embodiments of the present disclosure. For simplicity and clarity of illustration, reference numerals may be repeated among the Figures to indicate corresponding or analogous elements. Numerous details are set forth to provide an understanding of the example embodiments described herein. The example embodiments may be practised without some of these details. In other instances, well-known methods, procedures, and components have not been described in detail to avoid obscuring the example embodiments described. The description is not to be considered as limited to the scope of the example embodiments described herein.

Any reference to direction or orientation stated herein is for convenience and is not intended to be limiting unless explicitly stated herein. Any directional references in relation to the graphical user interface (GUI) are relative to the screen orientation of the GUI rather than a fixed point or reference on the host electronic device. The term “user interface” is sometimes used herein to refer to the GUI for convenience. For the purpose of the present disclosure, the terms device orientation and device position are treated equivalently. The term “collaborating devices” means client devices, such as computers or mobile devices, which are currently connected to a server and accessing the same application under development unless otherwise indicated either explicitly or implicitly. The terms “client device” and “client” are used interchangeable within the present disclosure.

Operating systems and applications often make use of images called “splash screens” when launching applications. Typically, splash screens display the company logo/branding or the application name/branding splash screens which do not reflect the rendered state of the application because acquiring images from the rendered application is difficult and time consuming, and requires the updating of the splash screen each time the rendered state of the application is updated. The present disclosure provides a method, system and devices which automate the creation of splash screen images that are based on a rendering of the real application. The present disclosure provides a web-based tool, including an editor, which permits users to acquire a render images of the application or document published to a connected device, such as a test device.

In accordance with one example embodiment, there is provided a method for acquiring an image for an application, comprising: sending a screenshot instruction to a target device upon detecting a trigger event; receiving image data from the target device in response to the screenshot instruction; and upon receiving the image data, automatically storing the image data and associating the image data with the application.

In accordance with another example embodiment, there is provided a system for developing applications for use on a mobile electronic device, comprising: a communication interface; a storage; a processor configured for: sending a screenshot instruction to a target mobile electronic device through the communication interface upon detecting a trigger event; receiving image data through the communication interface from the target device in response to the screenshot instruction; and upon receiving the image data, automatically storing the image data in the storage and associating the image data with the application.

In accordance with a further embodiment of the present disclosure, there is provided a mobile electronic device comprising: a communications interface; a display screen; a storage having a version of an application stored thereon; a processor configured for: receiving through the communications interface a screenshot instruction indicating a desired orientation; generating image data representing a screenshot of an image displayed on the display screen in the desired orientation; and sending the image data through the communications interface.

In accordance with yet a further example embodiment, there is provided an electronic device including a communication interface and a processor configured to perform methods described herein.

In accordance with yet a further example embodiment, there is provided a server including a communication interface and a processor configured to perform methods described herein.

In accordance with yet a further embodiment of the present disclosure, there is provided a computer readable medium having stored thereon computer program instructions for causing an electronic device or a server to perform methods described herein.

The present disclosure provides methods and devices for real-time collaboration on an application under development among two or more collaborating devices, which may be at the same or different locations. A server stores the application code for the application. Changes to the application, which may be additions, deletions or modifications, made by the collaborating devices are sent to the server. The server then distributes the changes to other collaborating devices in real-time or near real-time, which update the current state of the application to reflect the changes.

The present disclosure provides a web-based integrated development environment (IDE) tool which may allow multiple users to collaborate on a coding project, such as the development of an application for a mobile device. Typically, collaborative application development involves multiple users making independent changes in a separate copy of the application, and later merging the changes together in some manner. This can be a cumbersome task and some external co-ordination of tasks may be required since the tasks need to be carried out independently before the tasks can be combined. This can be especially problematic if two users want to collaborate on aspects of a user interface which are highly “visual”. Code changes made by one user may have a direct and notable effect on another user. For example, if a designer wishes to change the visual assets of an application, a developer may also have to change the positioning or behaviour of certain user interface elements to reflect the changes, but it may not be apparent that such changes are required until the changes of the developer are combined with the changes of the designer.

The web-based IDE tool of the present disclosure allows real-time collaborative application development and optionally “always-save” functionality. An application may be shared between two or more users using the web-based tool. Each user runs the tool in a Web browser on a computer with a persistent connection (e.g., HTTP connection, HTTPS connection, etc.) to a central server. If any user makes a change to the application, the change is sent to the devices of other users in the group which are online and the displayed application is automatically updated to reflect the change. As a result, all of the collaborating users have the current state of the application at all times and there is no need to perform manual synchronization to bring individual changes by the users together. Rather than working independently, the users work truly collaboratively.

The types of changes may include: (1) object creation (i.e., a new user interface control may be dropped onto a page)—this change includes information about the active page, the parent object that received the new object, the index/position within the parent where the new object was placed, etc.; (2) object deletion (i.e., an existing user interface control is dragged from a page)—this change includes information about the active page, and the object that was removed from the page; and (3) object change (i.e., some property of an existing user interface control is modified)—this change includes information about the active page, the object that was modified, the specific property that was modified, and the new property value. Other changes can include, for example, page creation and page deletion, etc.

For every change, enough information is provided to apply the change, and optionally enough information to reverse (i.e., rewind/undo) the change. This information may be used in conjunction with a visual timeline to move back and forth through a series of changes to the application.

Each collaborating device which is connected to the server may receive changes to the application state stored from the server which stores the application code at various states and incremental changes between such states. When the application state is updated in response to a change made by a collaborating device, the server may notify all of the other collaborating devices with the details of the change so that the other collaborating devices can all apply the change in real-time or near real-time. As a result, the displayed application on each collaborating device may be updated to reflect the current state of the application in real-time or near real-time. Thus, for example, if a first user is viewing a page that a second user is editing, the first user can see any changes to that made to the page by the second user in real-time or near real-time, regardless of whether the first user is working on the page being viewed. The first user and second user could even be manipulating different properties of the same user interface element. It is contemplated that the first user and second user could possibly even be manipulating the same properties of the same user interface element. While this could cause conflicts in some instances, one or more conflict resolution techniques could be used to resolve such conflicts. For example, a last change wins rules could be implemented which means whichever change was made last will be implemented. Other approaches could be used.

In one embodiment, the server also saves the entire list of incremental changes so that the application can be rebuilt from any previous save point by starting at the save point and then applying all of the subsequent incremental changes. This results in an effect similar to “autosave”, thereby providing “always-save” functionality. If a user forgets to save the changes to the application before exiting the Web browser, or if the Web browser terminates unexpectedly, the state of the application can be restored using the list of incremental changes.

In some embodiments, the user never has to explicitly save the application. Rather, the server saves all incremental changes, and the server or one or more of the clients may periodically and automatically select points at which to create a save point without the user being aware that it has happened. For example, after changes that are particularly computationally expensive to apply, the server may automatically save the application so that the expensive change does not have to be applied the next time the application is opened.

Similarly, a visual timeline or “undo history” for the application can actually extend back in time to the beginning of the application even if there have been save points in between. This may allow a user to reverse (i.e., rewind/undo changes) the application to the very beginning, regardless of whether or when the application was last explicitly saved.

The web-based tool of the present disclosure may also facilitate working with image assets by providing automatic propagation of updated images, in an attempt to obviate at least some of the shortcomings conventionally experienced during collaborative application development. When working in code, image assets can be difficult to visualize. In particular, if a user makes a change to an image asset, viewing the updated asset in context in the editor may require a “refresh” of the editor user interface screen. Viewing the image asset in context on a test device may require a compilation and deployment step. This can introduce considerable waiting time each time an image is updated, and if several iterations are required, then this can be a time-consuming process. If multiple users are collaborating on the same application, one user such as a designer may be updating image assets while another user such as a developer may be updating other aspects of the application. In such cases, it is important for the developer to have up to date visual assets in order to work effectively. Avoiding a manual “refresh” is advantageous since it is time consuming and requires the developer to remember to periodically perform the refresh.

The web-based tool of the present disclosure allows image objects in an editor user interface screen to maintain a dynamic link to the image that the image objects. If a user adds replaces an existing image, for example by dragging a new image into the editor user interface screen, all instances of the existing image are automatically and instantly replaced with the new image without requiring a manual refresh. If a test device is connected for live publishing, then the updated image is automatically pushed to the test device as well. The images may be updated immediately without the need to restart the running application on the connected test device, and without a manual refresh or compilation. If multiple users are collaborating on the same application and one user updates an image asset, the client collaborating devices of the other users may be notified that the image has changed and the client collaborating devices all pick up the new image asset automatically. The client collaborating devices may then automatically update all instances of the existing image without a manual refresh or compilation. As a result, the images are kept “in synch” between all live instances of the application, in the local editor, in remote editors, and on any connected test devices.

It will be appreciated that there may be multiple instances of a single image (e.g., multiple controls that share the same background image) and that all instances are updated immediately as soon as the new image asset changes. The web-based tool also cooperates with a “connected device” that is actually executing the code from the editor in real-time. It is also contemplated that the automatic propagation of the web-based tool could be applied to other types of assets such as XML, text, etc.

The web-based tool of the present disclosure may also allow multiple users, such as a community of developers and designers, to collaborate on a number of projects, such as applications for mobile devices. Users can see the active applications and the changes in those applications.

In one embodiment, one or more pages from one or more applications which a user has access to are presented. The pages may show a number of applications at one time, show the changes being made as the changes happen in the same fashion as changes to a particular application the user is working on is shown, and may also show who is working on which applications in real-time or near real-time. A user has access to applications created by the user, applications explicitly shared with the user, and public applications that all users can access.

For each of the applications that a user has access to, the collaborating device may request the current state and render the current state of the application. All or a subset of the pages of the application can be rendered. The rendered applications can be sorted according to most recently created, or most recently edited, or other criteria. When a persistent connection to the server is established, each collaborating device receives changes to the each application a respective user has access to. When a change is made to one of the applications, the server will return the details for the change and it can be applied to the corresponding page of the corresponding application. Optionally, the page of the application may move or “bubble” of the top of the displayed pages of the applications to bring the application in view if it was below the page scroll, or otherwise bring the changed application to the attention of the user. A description or note describing who is working in the application may be displayed in association with the page. Because the server knows the last incremental change for each user, and how long ago the change happened, the collaborating device can accurately place user avatars in association with the applications which users are working on.

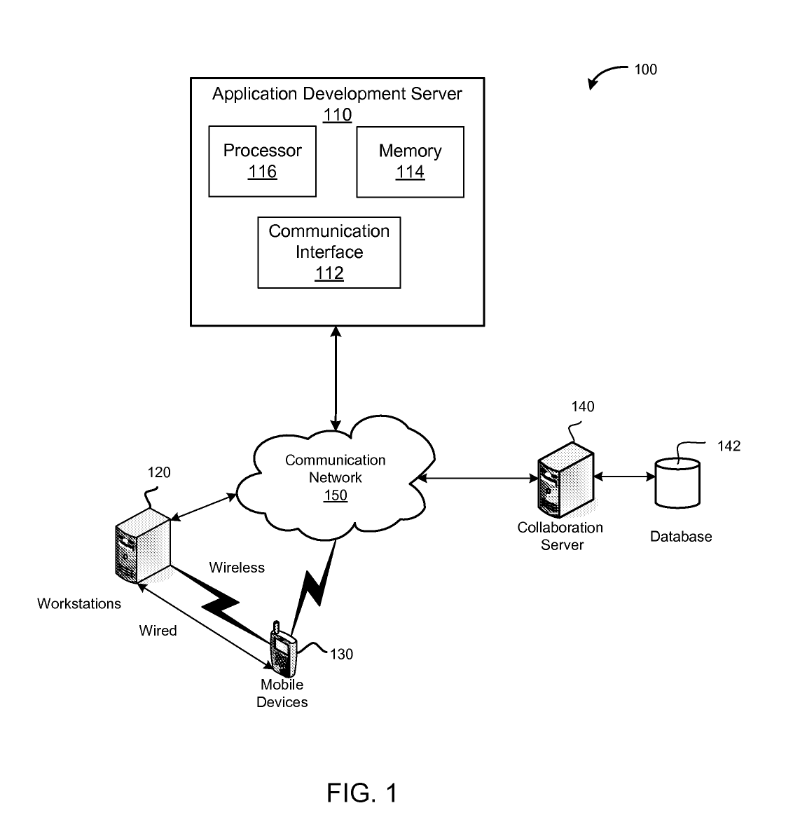

Referring first to FIG. 1, a communication system 100 in accordance with example embodiments of the present disclosure is shown. The architecture includes an application development server (ADS) 110, one or more general purpose computers 120 (only one of which is shown in FIG. 1), one or more mobile communication devices 130 (only one of which is shown in FIG. 1) optionally connected to a computer 120 via a wired link (e.g., Universal Serial Bus (USB)) and/or wireless link (e.g., Wi-Fi or possibly Bluetooth™), and one or more collaboration servers 140 (only one of which is shown in FIG. 1) each having an application database 142, each of the devices having access to a communication network 150, e.g., the Internet. The mobile communication devices 130 may also directly connect to the ADS 110 over a wireless network via wireless link.

The communication network 150 may include a number of wired and/or wireless networks. The communication network 150 may include public and/private networks, for example, the communication network 150 may comprise a private local area network (LAN), metropolitan area network (MAN), wide area network (WAN), the public Internet or combinations thereof and may include virtual networks constructed using any of these, alone, or in combination. Computers 120 may be connected to the communication network 150 directly or indirectly via an intermediate communication network such as the Internet. A VPN or other mechanism for securely connecting to the communication network 150 may be required when computers 120 connect to the communication network 150 indirectly, e.g. via the Internet.

The wireless networks may comprise one or more of a Wireless Wide Area Network (WWAN) and a Wireless Local Area Network (WLAN) or other suitable network arrangements. The computers 120 and mobile communication devices 130 may be configured to communicate over both the WWAN and WLAN, and to roam between these networks. The wireless network may comprise multiple WWANs and WLANs.

The mobile communication devices 130 may interface with a computer 120 connected to the communication network 150 via one or both of a physical interface and short-range wireless communication interface to provide a direct connection. The physical interface may comprise one or combinations of an Ethernet connection, USB connection, Firewire™ (also known as an IEEE 1394 interface) connection, or other serial or parallel data connection, via respective ports or interfaces of the connecting devices. The short-range wireless communication interface may be a personal area network (PAN) interface. A personal area network is a wireless point-to-point connection meaning no physical cables are required to connect the two end points. Alternatively, in embodiments, in which the ADS 110 is able to contact the mobile communication device 130 directly, then the direct connection between the computer 120 and the mobile communication device 130 may be omitted.

In the shown example, the communication system 100 includes one or more separate collaboration servers 140 each having an application database 142. The collaboration servers 140 may be located at the same or different locations. The collaboration servers 140 may each be restricted to a set of users/devices, such as those of a particular enterprise (e.g., business or organization), or may be open to all users/devices connected to the ADS 110. The databases 142 are used to store applications and applications under development including application source code, application machine code/compiled source code, application data, user information, change logs, images, libraries, and other application data. A collaboration server 140 could be hosted on a computer 130 in some embodiments. In other embodiments, the functions of the collaboration servers 140 may be performed by the ADS 110 rather than having separate collaboration servers 140, and the contents of the application database 142 may be stored in local or remote storage of the ADS 110.

It will be appreciated that the above-described communication system is provided for the purpose of illustration only, and that the above-described communication system comprises one possible communication network configuration of a multitude of possible configurations. Suitable variations of the communication system will be understood to a person of skill in the art and are intended to fall within the scope of the present disclosure.

Each of the computers 120 has client software which allows the computers to connect to server software on the ADS 110 for operating the IDE application development tool. In the described embodiment, the computers 120 include an Internet browser and connect to a Web server provided by the ADS 110. The majority of the logical of the ADS 110 is located on the ADS 110. The ADS 110 is a Web server and can be any one or more general purpose computing systems providing sufficient processing resources and interfaces to interact with an anticipated number of devices. The application development tool will be described in more detail below.

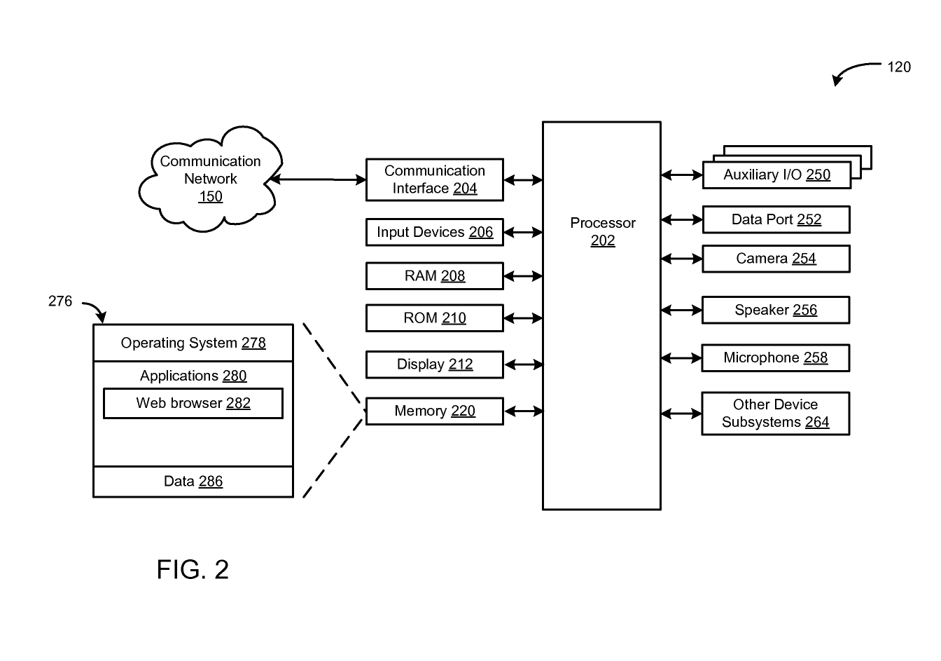

Reference is next made to FIG. 2 which shows a computer 120 suitable for executing an IDE application development tool in accordance with example embodiments of the present disclosure. The computer 120 includes a rigid case (not shown) housing the electronic components of the computer 120 computer 120. The electronic components of the computer 120 are mounted on a printed circuit board (not shown). The computer 120 includes a processor 202 which controls the overall operation of the computer 120 and a communication interface 204 for communicating with other devices via the communication network 150.

The processor 202 interacts with other components, such as one or more input devices 206 such as a keyboard and mouse, Random Access Memory (RAM) 208, Read Only Memory (ROM) 210, a display 212, persistent (non-volatile) memory 220 which may be flash erasable programmable read only memory (EPROM) memory (“flash memory”) or any other suitable form of memory, auxiliary input/output (I/O) subsystems 250, data port 252 such as a serial data port (e.g., Universal Serial Bus (USB) data port), camera 254 such as video and/or still camera, speaker 256, microphone 258 and other device subsystems generally designated as 264. The components of the computer 120 are coupled via a communications bus (not shown) which provides a communication path between the various components.

The display 212 may be provided as part of a touchscreen which provides an input device 206. The display 212 which together with a touch-sensitive overlay (not shown) operably coupled to an electronic controller (not shown) comprise the touchscreen. User-interaction with the GUI is performed through the input devices 206. Information, such as text, characters, symbols, images, icons, and other items are rendered and displayed on the display 212 via the processor 202.

The processor 202 operates under stored program control and executes software modules 276 stored in memory, for example, in the persistent memory 220. The persistent memory 220 also stores data 386 such as user data. As illustrated in FIG. 2, the software modules 276 comprise operating system software 278 and software applications 280. The software applications 280 include a Web browser 282. The software modules 276 or parts thereof may be temporarily loaded into volatile memory such as the RAM 208. The RAM 208 is used for storing runtime data variables and other types of data or information. Although specific functions are described for various types of memory, this is merely one example, and a different assignment of functions to types of memory could also be used.

Application data associated with an application under development and the IDE is provided by the Web browser 282 such that no application data or IDE software is stored on the computer 120 with the exception of data stored temporarily in cache or the like. Accordingly, the computer 120 provides a thin client with little or no processing logic. The IDE and application data, such as source code and other data associated with applications under development, digital media such as images, and change logs, is stored in a remote database, such as the memory 114 of the ADS 110. In other embodiments, the local storage of the Web browser 282 may be used to save some application data (also referred to as project data).

The communication interface 204 may include a short-range wireless communication subsystem (not shown) which provides a short-range wireless communication interface. The short-range wireless communication interface is typically Bluetooth® interface but may be another type of short-range wireless communication interface including, but not limited to, an infrared (IR) interface such as an Infrared Data Association (IrDA) interface, an IEEE 802.15.3a interface (also referred to as UltraWideband (UWB)), Z-Wave interface, ZigBee interface or other suitable short-range wireless communication interface.

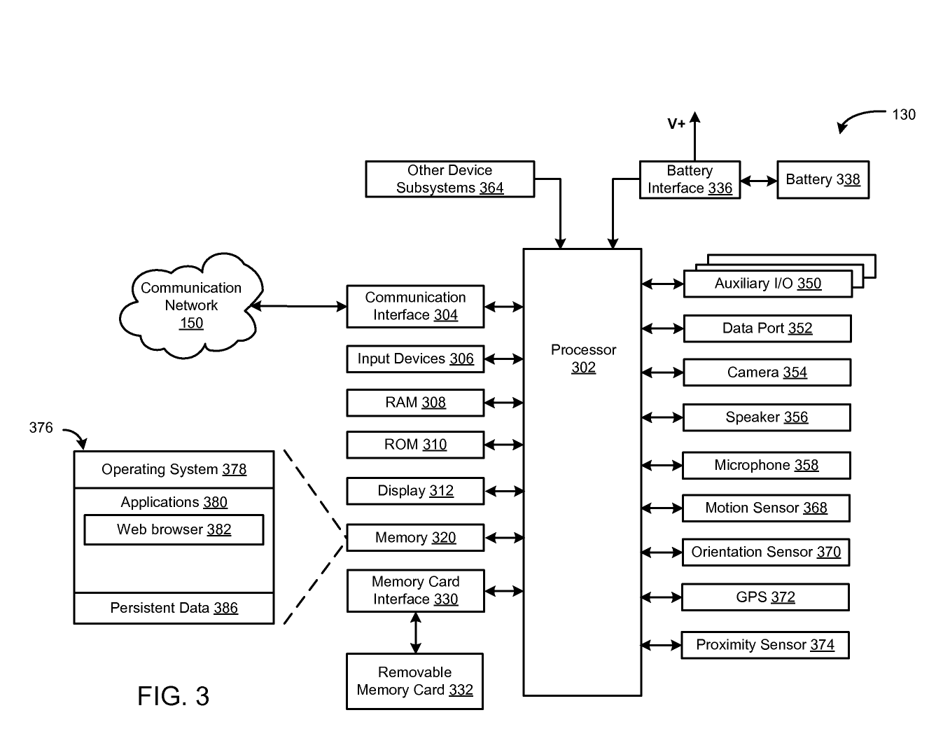

Reference is next made to FIG. 3 which illustrates a mobile communication device 130 (referred to hereinafter as merely mobile device 130 for convenience) suitable for interacting with a computer operating an IDE application development tool in accordance with example embodiments of the present disclosure and for operating as a device under test. Examples of the mobile device 130 include, but are not limited to, a mobile phone, smartphone or superphone, tablet computer, notebook computer (also known as a laptop, netbook or ultrabook computer depending on the device capabilities), wireless organizer, personal digital assistant (PDA), electronic gaming device, and special purpose digital camera.

The mobile device 130 includes a rigid case (not shown) housing the electronic components of the mobile device 130. The electronic components of the mobile device 130 are mounted on a printed circuit board (not shown). The mobile device 130 includes a processor 302 which controls the overall operation of the mobile device 130. Communication functions, including data and voice communication, are performed through a communication interface 304. The communication interface 304 receives messages from and sends messages via the communication network 150. The communication interface 304 typically includes a WWAN interface for communication over cellular networks and a WLAN interface for communication over Wi-Fi networks.

The processor 302 interacts with other components, such as one or more input devices 306, RAM 308, ROM 310, a display 312, persistent (non-volatile) memory 320 which may be flash memory or any other suitable form of memory, auxiliary I/O subsystems 350, data port 352 such as serial data port (e.g., Universal Serial Bus (USB) data port), camera 354 such as video and/or still camera, speaker 356, microphone 358, a motion sensor 368 which enables to processor 302 to determine whether the mobile device 130 is in motion and the nature of any sensed motion at any appropriate time, an orientation sensor 370 which enables the processor 302 to determine which direction the mobile device 130 is pointed at any appropriate time, a global positioning system (GPS) device 372 which enables the processor 302 to determine GPS coordinates (i.e., location) of the mobile device 130 at any appropriate time, proximity sensor 374 which enables the processor 302 to determine the distance between the mobile device 130 and an object at any appropriate time, and other device subsystems generally designated as 364. The components of the mobile device 130 are coupled via a communications bus (not shown) which provides a communication path between the various components.

The display 312 may be provided as part of a touchscreen which provides an input device 306. The display 312 which together with a touch-sensitive overlay (not shown) operably coupled to an electronic controller (not shown) comprise the touchscreen. User-interaction with the GUI is performed through the input devices 306. Information, such as text, characters, symbols, images, icons, and other items are rendered and displayed on the display 312 via the processor 302. The processor 302 may interact with the orientation sensor 370 to detect direction of gravitational forces or gravity-induced reaction forces so as to determine, for example, the orientation of the mobile device 130 in order to determine a screen orientation for the GUI.

The input devices 306 may include a keyboard, control buttons (not shown) such as a power toggle (on/off) button, volume buttons, camera buttons, general purpose or context specific buttons, ‘back’ or ‘home’ buttons, phone function buttons, and/or a navigation device. When the display 312 is provided as part of a touchscreen, the various buttons or controls may be provided by onscreen user interface elements displayed on the display 312 instead of, or in addition to, physical interface components. The keyboard may be provided instead of, or in addition to, a touchscreen depending on the embodiment. At least some of the control buttons may be multi-purpose buttons rather than special purpose or dedicated buttons.

The mobile device 130 also includes a memory card interface 330 for receiving a removable memory card 332 comprising persistent memory, such as flash memory. A removable memory card 332 can be inserted in or coupled to the memory card interface 330 for storing and reading data by the processor 302 including, but not limited to still images and optionally video images captured the image capture assembly 200. Other types of user data may also be stored on the removable memory card 332. Other types of removable digital image storage media, such as magnetic hard drives, magnetic tape, or optical disks, may be used in addition to, or instead of, the removable memory card 332.

The processor 302 operates under stored program control and executes software modules 375 stored in memory, for example, in the persistent memory 320. The persistent memory 320 also stores data 386 such as user data, user information and information regarding the components and technical capabilities of the mobile device 130. As illustrated in FIG. 3, the software modules 376 comprise operating system software 378 and software applications 380. The software applications 380 may include a Web browser 382. The software modules 376 or parts thereof may be temporarily loaded into volatile memory such as the RAM 308. The RAM 308 is used for storing runtime data variables and other types of data or information. Although specific functions are described for various types of memory, this is merely one example, and a different assignment of functions to types of memory could also be used.

One or more mobile devices 130 may be configured as a test device for testing applications under development, hereinafter referred to as test devices. The test devices may have differing technical capabilities, such as different display sizes, display shapes (e.g., aspect ratio), and display resolutions, as well as different primary input devices 306 (e.g., touchscreen only, touchscreen and keyboard, keyboard and conventional non-touchscreen display 312). The test devices include communication modules for communicating with the ADS 110 and/or computer 120, depending on the embodiment.

The communication interface 304 may include a short-range wireless communication subsystem (not shown) which provides a short-range wireless communication interface. The short-range wireless communication interface is typically Bluetooth® interface but may be another type of short-range wireless communication interface including, but not limited to, an IR interface such as an IrDA interface, an IEEE 802.15.3a interface (also referred to as UWB), Z-Wave interface, ZigBee interface or other suitable short-range wireless communication interface.

The mobile device 130 also includes a battery 338 as a power source, which is typically one or more rechargeable batteries that may be charged, for example, through charging circuitry coupled to a battery interface such as the serial data port 352. The battery 338 provides electrical power to at least some of the electrical circuitry in the mobile device 130, and the battery interface 336 provides a mechanical and electrical connection for the battery 338. The battery interface 336 is coupled to a regulator (not shown) which provides power V+ to the circuitry of the mobile device 130.

A received signal, such as a text message, an e-mail message, or web page download, is processed by the communication subsystem 304 and input to the processor 302. The processor 302 processes the received signal for output to the display 312 and/or to the auxiliary I/O subsystem 350. A subscriber may generate data items, for example e-mail messages, which may be transmitted over the communication network 150 through the communication subsystem 304, for example.

The motion sensor 368 may comprise an accelerometer (such as a three-axis accelerometer) or other suitable motion sensor. The orientation sensor 382 may comprise an accelerometer (such as a three-axis accelerometer), electronic compass, gyroscope, or a combination thereof. Other suitable orientation sensors could be used instead of, or in addition to, the accelerometer, electronic compass and gyroscope. The motion sensor 368 and orientation sensor 382, or parts thereof, may be combined or shared, for example, within an integrated component. The processor 302, or controller (not shown) of a three-axis accelerometer, can convert acceleration measurements into device orientations.

The proximity sensor 374 may comprise a sensor that transmits a field or signals (such as electromagnetic) to detect the presence of nearby objects (i.e. the sensor's target). The maximum distance that the proximity sensor 374 can detect is may be predetermined or adjustable. The processor 302 can utilize this information to determine the distance between the mobile device 130 and the target object to be captured in an image.

The mobile device 130 may connect to a computer 120 via the data port 352, such as a USB connection or Firewire™ connection, or a short-range communication interface, such as a Bluetooth™ connection.

### Application Framework

The IDE and application development tool of the present disclosure, in at least some embodiments, may be configured to develop applications for use with, for example, the Cascades™ application framework for the BlackBerry™ 10 operating system. The Cascades™ application framework includes Cascades™ application programming interfaces (APIs), Qt APIs, Cascades™ libraries, Qt libraries for developing applications for mobile devices 130 and optionally native C/C++ APIs. In other embodiments, the Cascades™ application framework could support one or more operating systems in addition to, or instead of, the BlackBerry™ 10 operating system. In yet other embodiments, the IDE and application development tool could use a different application framework for developing applications for mobile devices 130 using one or more different operating systems, or could use a cross-platform application framework for developing applications for mobile devices 130 using one of a number of different operating systems.

As will be appreciated to persons skilled in the art, Qt is a cross-platform application framework commonly used for developing applications with a GUI (in which cases Qt is classified as a widget toolkit). Qt is based on C++ but uses a special code generator called the Meta Object Compiler (MOC) together with several macros to extend the language. The Cascades™ application framework leverages the Qt object model, event model and threading model. The slots and signals mechanism in Qt allows for useful and flexible inter-object communication. The Cascades™ application framework incorporates features of fundamental Qt classes (such as QtCore, QtNetwork, QtXml, and QtSql, and others) and builds on these Qt classes.

The Cascades™ application framework separates application logic and user interface elements. Application logic is handled by an interpreter and user interface elements are rendered by a user interface (UI) rendering engine. The type of each UI control in an application, its properties and behavior are declared. When the application is run, the UI rendering engine displays the UI controls and applies any transitions which have been specified. In contrast, in a traditional, window-based UI framework, a simple animation or transition might require hundreds of lines of code. To create a sophisticated UI within a window-based UI framework, a lot of code may be required to locate UI controls where and when the UI controls are needed. Additionally, the graphics code for a UI can be difficult to maintain using a window-based UT framework especially for multiple screen sizes.

The application logic (or business logic) and the UI rendering engine run on separate execution threads that communicate asynchronously. The separation of application and rendering logic means that the UI rendering engine does not need to wait for a long running computation to complete before updating the UI. This makes the Cascades™ application framework both fast and easy to use, and helps applications present a UI at a consistently high frame rate which keeps the UI smooth and responsive.

Within the Cascades™ application framework, each application comprises as a number of interconnected pages in which each page is configured to be displayed on the display of a mobile device 130. Each page is written in Qt Modeling Language (QML) and comprises one or more QML document files. It is contemplated that the QML code in a page could interact with native (C++) code as noted below. The application logic defines how the pages interact with each other and input and output data, whereas the user interface elements define how the appearance of the pages. Typically, each page is configured to be displayed full screen on the display of a mobile device 130. The screen orientation in which each page is displayed is defined by the application and reflected in the orientation of the user interface elements. The page size and aspect ratio of each page is also defined by the application and reflected in the page size and aspect ratio of the user interface elements of each page. It will be appreciated; however, that more than one page size and/or aspect ratio may be supported by an application, in which case the page size and aspect ratio are defined on per device configuration basis. Each page typically has its own unique identifier (ID) such as the file name of the page.

Each QML document includes one or more QML objects each having a number of properties which depend on the type of object. The QML objects within each QML document are linked in a hierarchical relationship. Each QML object has a unique ID. The unique ID, in at least some embodiments, is automatically assigned when the object is created in accordance with a predefined algorithm, and typically consists of a prefix which specifies the object type and a suffix which specifies the object's number in the total number of objects of that type. The unique ID which is assigned may be changed by the user.

The application development tool of the present disclosure utilizes a UI rendering engine for rendering UI elements of an application on client devices, such as computers 120, connected to the ADS 110 via the Internet. The client devices include a QML parser written in JavaScript which parses the QML of the application pages. The QML parser may be downloaded as part of the content downloaded by the Web browser 282 on the computer 120 when accessing the website where the application development server is hosted. When the application is published to a supported mobile device 130, a QML parser is provided as part of the Cascades™ UI rendering engine on the mobile device 130, for example, as part of the operating system 378 or application 380.

The Cascades™ application framework supports applications written in C++, QML, or a combination of C++ and QML. QML is a declarative language that is based on JavaScript which was developed to create user interfaces using a powerful but simple language. QML can be used to describe the structure and behavior of a set of UI controls. QML uses concepts such as objects, properties, and signals and slots to let objects communicate with each other.

The Cascades™ application framework uses a modified form of QML for creating UIs in applications. QML makes it easy to identify the relationships between the various components in an application, as described in more detail below. QML allows developers to more easily see how UI controls are related to each other and how the controls may be laid out visually in an application. One control can belong to another control (that is, being owned by another control) using object ownership, discussed below.

Each Cascades™ UI control is represented by an underlying C++ class. For most properties of QML controls, there are associated C++ functions that can be used to retrieve or set the values of these properties. As noted above, applications can be made using QML, C++ or both. However, even if an application is entirely in QML, C++ code is typically used to load the QML and get the application started. This C++ code is provided by the IDE and application development tool when an application is created.

QML is typically used to define the look and feel of an application. Core UI controls, such as buttons, text fields, labels, sliders, and drop-down menus can be used, or custom controls can be created, and user interaction like button clicks can be responded to. Different layouts can be used to arrange the controls to get the desired look. With QML, visual designs can be created and tested quickly and easily.

C++ is typically used to take care of the business logic of the application. C++ classes can be created and used to perform calculations, handle data storage operations, and so on. The full capabilities of C++ can be used to supplement the UI-related features provided by QML.

By using QML for the UI and C++ for business logic, one aspect of an application can be changed without affecting another. For example, the appearance of a list of items can be changed without worrying about how the data for the list is stored or accessed. Or, a new sorting algorithm can be implemented in the application without affecting how the data is shown.

Controls and events are C++ objects that are exposed using QML. An application UI can be declared in QML and events can be processed using JavaScript in line with the QML. If an application has a computationally intensive process or a sophisticated user interaction scenario that cannot process in QML and JavaScript, C++ objects can be used instead.

The Cascades™ application framework includes a set of core UI components designed to have a consistent look and feel which are optimized for touchscreen interaction which can be used when developing an application. The core controls include:
Button—a clickable button that can contain text, an image, or both;
CheckBox—a check box that a user can check or clear;
ToggleButton—an option button with only two states: on or off;
Slider—a slider that lets a user select a value within a specified range of values;
Label—a non-interactive label with a single line of text;
TextField—a text box into which a user can type text;
ImageView—a visual control for displaying an image.

Custom UI controls can be created from any two or more core UI controls by combining and extending core UI controls. For example, in an address book application, a custom control component for a contact may include an ImageView control for the contact's picture and a Label control for the contact's name. When a contact is displayed in the application, an instance of the custom control component is displayed instead of creating each control separately.

The Cascades™ application framework can also be used to add functionality to UI controls to create animations, handle touch events, apply text styles, and more.

The Cascades™ application framework also provides an event system which takes advantage of a slots and signals framework in Qt for inter-object communication. Objects can communicate with each other by emitting a signal. One object that wants to receive a message from another object can create a slot for a particular signal. Unlike the callback technique for inter-object communication, slots and signals are type-safe and loosely coupled. An object that implements a slot must match the method signature for the signal that it can receive. This approach allows the compiler to type-check the subscription. Apart from the data type in the signature, a slot implementation does not need to know anything about the signal implementation. The slot does not even need to receive the same number of arguments that a signal emits. Similarly, signals can be sent to objects if the slots which the signals implement are known. The Cascades™ application framework discards signal arguments that are not implemented by the slot. Accordingly, events in the Cascades™ application framework are implemented as signals. When a user interacts with the UI of an application, the Cascades™ application framework emits a signal. The Cascades™ application framework delivers the signal to each slot that is connected to the signal.

The Cascades™ application framework also animates any change in certain types of properties of a UI control by default. Properties which can be animated include:

Position;

Size;

Scale;

Rotation; and

Opacity.

The UI of an application operates as a collection of containers with which a user can interact. For example, assume a user is allowed to inspect the contents of a container when it is tapped. The Cascades™ application framework monitors for a touch event in the screen area occupied by the container and, in response to detecting a touch event in the screen area occupied by the container, changes the x and y coordinates and the height and width of the container to enlarge the displayed size of the container. When the x and y coordinates of the container are changed, the Cascades™ application framework slides the container from its current position to the target position. A traditional UI framework may simply draw the container again in its new location, but the Cascades™ application framework animates the change in position automatically. Similarly, when the height and width of the container are changed, the container is enlarged from its current size to the target size.

The Cascades™ application framework also provides fine control over animation. Transitions between pages (screens) can be explicitly specified transitions using classes which include:
FadeTransition—an animation that controls the opacity of a VisualNode;
RotateTransition—an animation that rotates a VisualNode around its z-axis;
ScaleTransition—an animation that scales the size of a VisualNode;
TranslateTransition—an animation that controls the position of a VisualNode;
EasingCurve—an abstract class for easing curves that are used with animations;
SequentialAnimation—a group animation that plays its children animations sequentially;
ParallelAnimation—a group animation that plays its children animations in parallel; and
GroupAnimation—abstract class containing properties exposed to group animations.

The Cascades™ application framework also provides a flexible layout system which adjusts the size and position of UI controls automatically. When additional controls are added to a container with a layout, the size and positioning parameters of the control can be configured to change relative to other controls in the layout. The Cascades™ application framework provides layouts which include:
StackLayout—arranges child controls vertically or horizontally relative to each other. This is the default layout for containers.
DockLayout—arranges child controls along the edge, or in the center, of the container specified by the child control.
AbsoluteLayout—requires that x and y coordinates of each control be specified. The origin of the coordinate system is the top-left corner of the control's parent container.

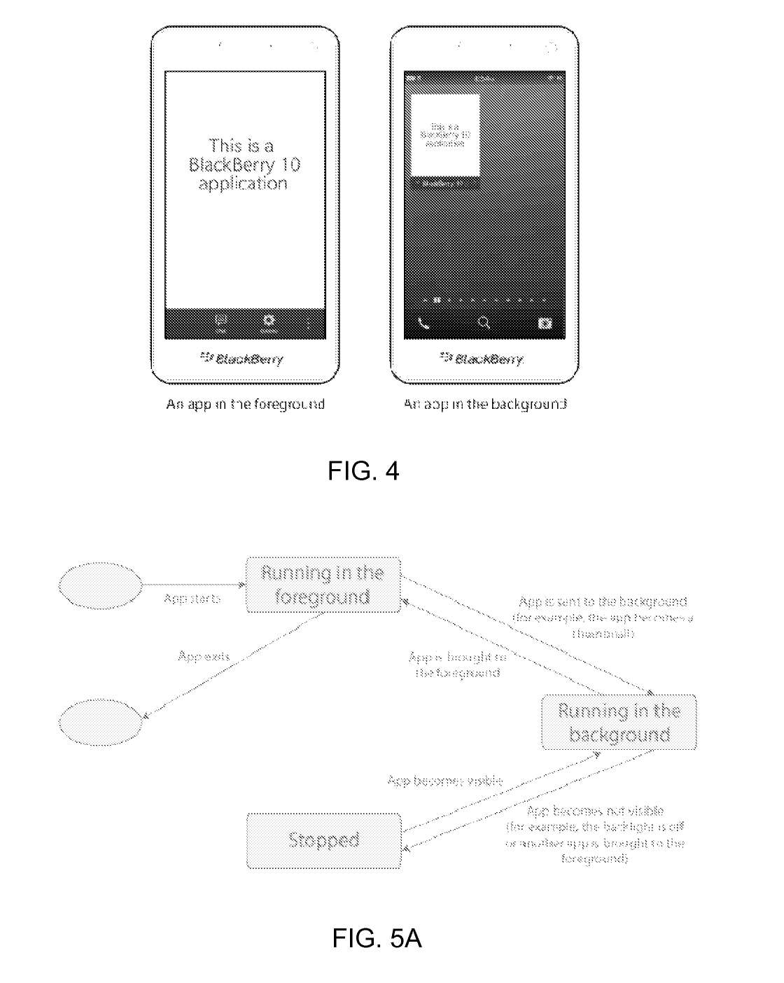

Applications developed using the Cascades™ application framework have a similar lifecycle that includes three possible operational states: running in the foreground, running in the background and stopped. An application is running in the foreground if it is currently visible and is taking up the entire screen. An application is running in the background if it is visible and is running in a reduced size (e.g., as a thumbnail), such as when a user swipes up from the bottom of the screen to display a list of running applications. An application is also considered to be running in the background if it is not visible but has the appropriate permissions to run in the background. An application is stopped if it is not visible and does not have permission to run in the background. FIG. 4 illustrates an application running in the foreground and the same application running in the background.

The operational state of an application may vary depending on user input and other factors. While applications can allow a user to directly interact with the application while running, applications do not require user input while running. This type of application may monitor for a particular event to occur on the mobile device 130 and then respond by notifying the user at that time. This type of applications is suitable to run in the background until the application needs to alert the user that the event has occurred. By default, an application enters the stopped operational state when it is in the background and not visible. The application cannot perform any operations in this operational state. Processor time is not allocated to applications in this operational state, so this helps to minimize battery power consumption and maximize the performance of the mobile device 130. However, an application may be set to continue running while it is in the background and is not visible by setting the appropriate permission. The Application class includes several signals that are emitted when the operational state of the application changes.

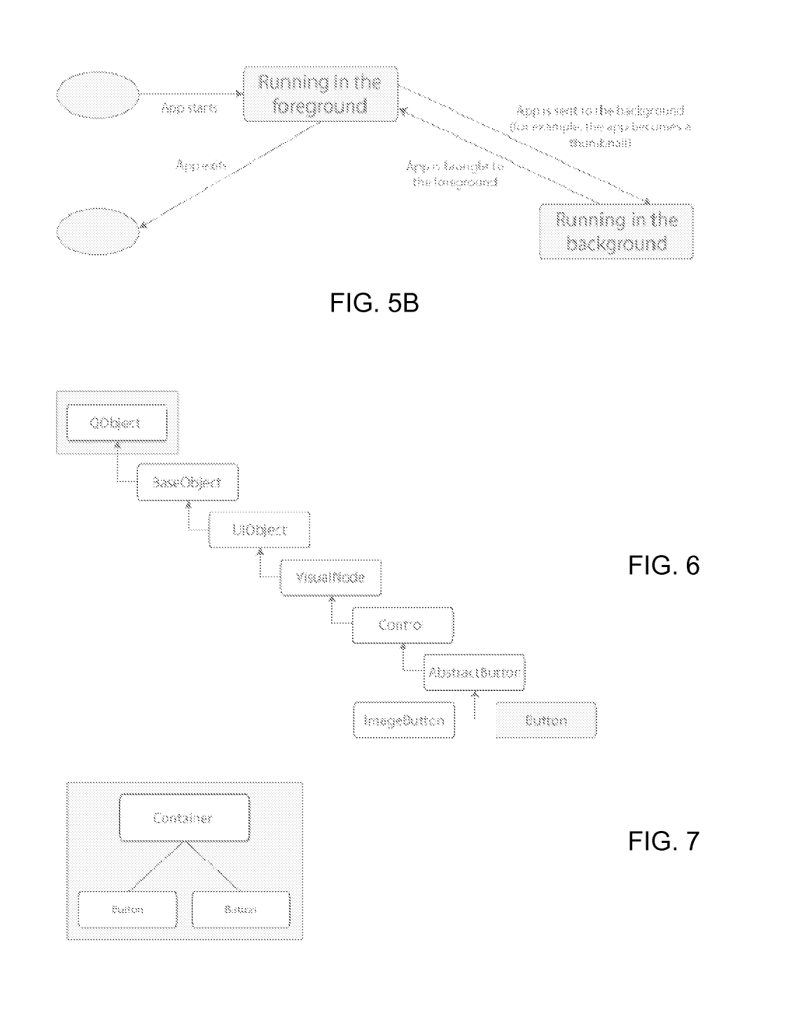

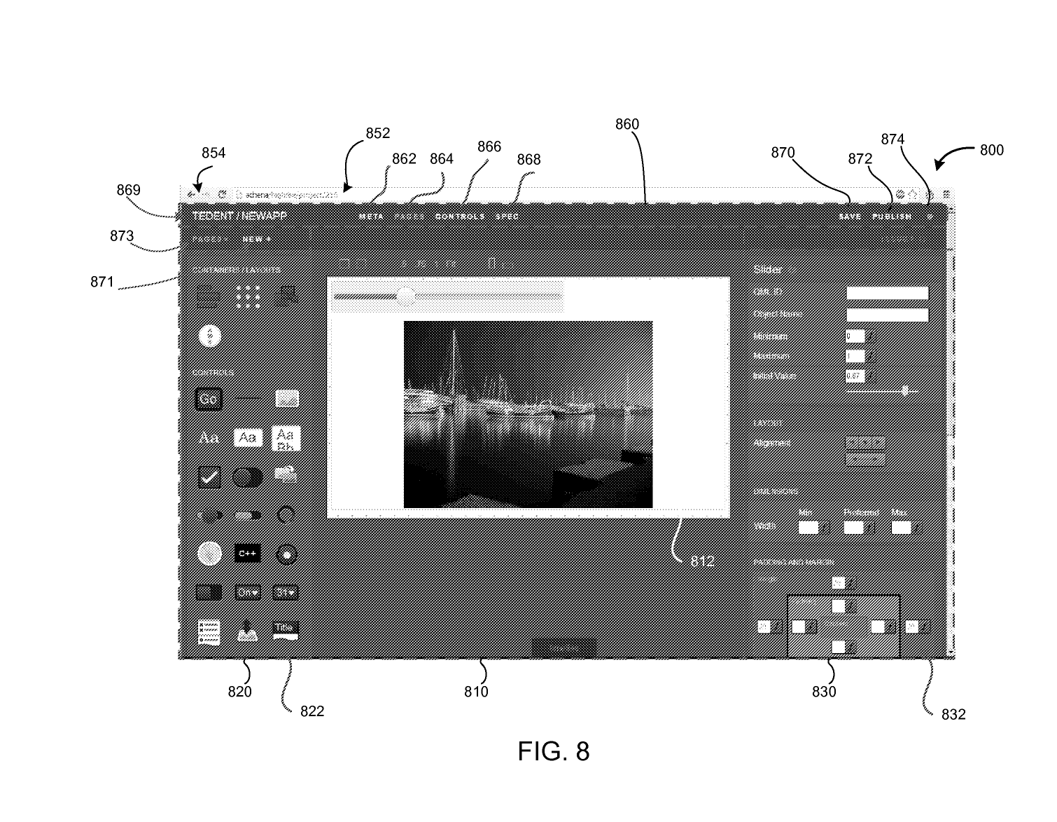

FIG. 5A illustrates an example of changes in the operational state of an application when an application does not have permission to run in the background and is not visible. The application lifecycle includes the stopped operational state. An application enters the stopped operational state, for example, when it is in the background and not visible—the application cannot perform any operations in this operational state.

FIG. 5B illustrates an example of changes in the operational state of an application when an application has permission to run in the background and is not visible. The application lifecycle does not include the stopped operational state. The application continues to run when it is in the background and not visible, and the application CaO continue to perform operations and process events in this operational state.

### QObject, the Qt Base Class

All objects in Cascades™ are derived from the QObject class. This class is the base class of all Qt objects and provides several important features. Most notably, QObject provides support for signals and slots, which is a mechanism that allows objects to communicate with each other. When something happens to an object in an application (for example, a user clicks a button), the object emits a signal. The application CaO respond to the emitted signal caused by the event by using a function called a slot.

This structure of a QObject subclass will now be briefly described by examining parts of a C++ header file to provide an understanding of the connection between QML elements (such as properties) and the C++ equivalents, which can be imported when custom control components are created used in conjunction with other QObject elements.

To illustrate some of the features and requirements of a QObject in Cascades™, consider the Button control. This control represents a clickable button that can be used in an application. The header file (button.h) for this control is located in the folder where the BlackBerry 10 Native SDK as installed, typically in the target\qnx6\usr\include\bb\cascades\controls subfolder.

### Class Declaration

class QT_CASCADES_EXPORT Button: public AbstractButton {

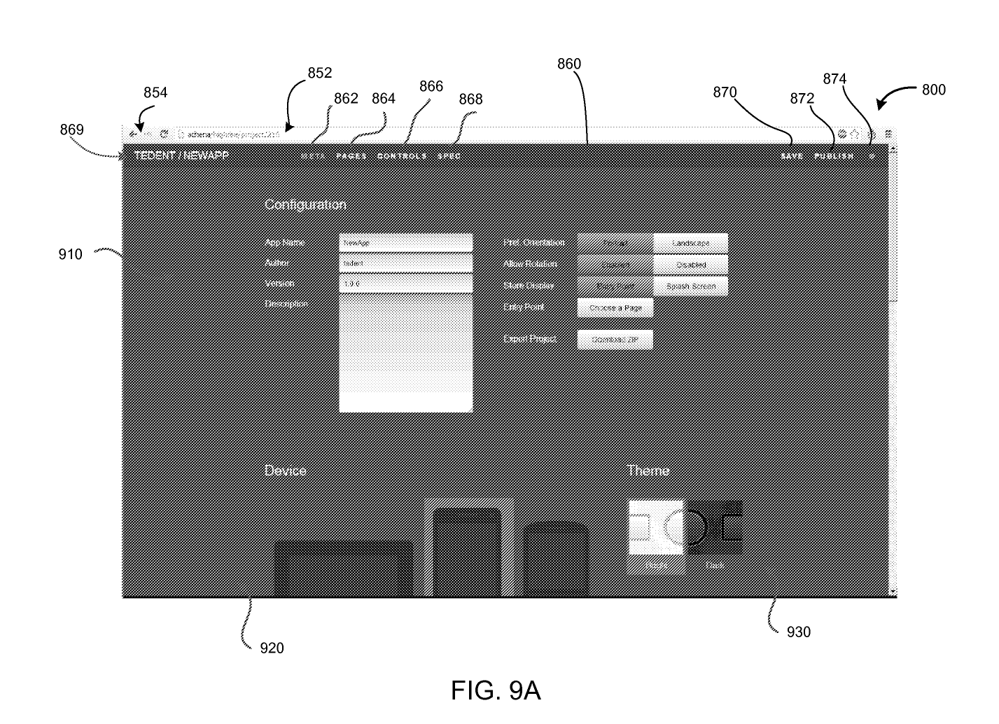

All Cascades™ controls inherit QObject, either directly or indirectly. FIG. 6 illustrates the inheritance chain associated with the Button control. The Button class inherits several intermediate classes, all of which eventually inherit QObject.

### Q_OBJECT Macro

private: Q_OBJECT

To identify a class as a QObject, the Q_OBJECT macro needs to be used in the private: section of the class definition. This macro is processed by the Qt Meta Object Compiler and enables features such as properties, signals, and slots.

### Property Declaration

Q_PROPERTY(QString text READ text WRITE setText RESET resetText NOTIFY textChanged FINAL)

A property is a single piece of information about an object, and is declared by using the Q_PROPERTY macro. This macro allows the property to be accessible in QML. Inside Q_PROPERTY, the name and type of the property can be specified. Keywords (such as READ and WRITE) can be used to specify the names of functions to manipulate the property value. Properties are declared in the private: section of the header file, along with the Q_OBJECT macro.

As shown above, the Button class includes the text property, which specifies the text to appear on the button. This property is a QString (the Qt representation of a text string) and has associated functions called text( ), setText( ), and resetText( ) to get, set, and reset the value of the property, respectively. These functions still need to be declared later; the Q_PROPERTY macro simply associates the functions with the property. A signal emitted when the value changes can be specified by using the NOTIFY keyword.

### Function Declaration

public: Q_SLOT void setText(const QString & text);

Functions for QObject classes can be created like any other C++ classes. However, the Q_SLOT macro is used before the function declaration. This macro is another special element of Qt and indicates that this function is a slot. Slots can be connected to signals so that when a signal is emitted, the connected slot function is called automatically. As an alternative to the Q_SLOT macro, slot functions can be declared in a public slots: section in a header file. In the Cascades™ application framework, these approaches are equivalent.

Q_INVOKABLE is another useful macro which can be used in front of a function declaration (in the same place as Q_SLOT above) to indicate that a function can be called from QML. This approach can be useful for a complicated operation (for example, a custom transition for a UI control) implemented in C++. The UI-related portion (calling the function at the appropriate time) can be called in QML but the operation in C++ can be implemented any way.

### Signal Declaration

Q_SIGNALS: void textChanged(QString text);

Q_SIGNALS: section can be used to declare signals that a QObject emits when certain events occur. A Button emits the textChanged( ) signal when its text changes, and this event can be handed within an application if needed. See signals may also be declared in a signals: section in a header file, which is equivalent in the Cascades™ application framework.

### Object Ownership

Every QObject can be related to other objects in parent/child relationships. An object can have one parent, as well as zero or more children. A parent object is said to own its child objects. When an object is destroyed, its children are also destroyed, so it is important to keep in mind which objects are related to other objects within an application.

### Scene Graphs

The Cascades™ application framework maintains the relationships between objects internally and automatically transfers ownership between objects when functions that change object ownership are called. To make it easier to visualize the parent/child relationships in an application, a structure called a scene graph is used. The scene graph illustrates nodes in an application, which are user interface control objects, and how the nodes are related to each other. The scene graph is a logical representation of user interface control objects which is typically not displayed to the designer. The scene graph makes it easier to visualize how the Cascades™ application framework internally keeps track of object relationships.

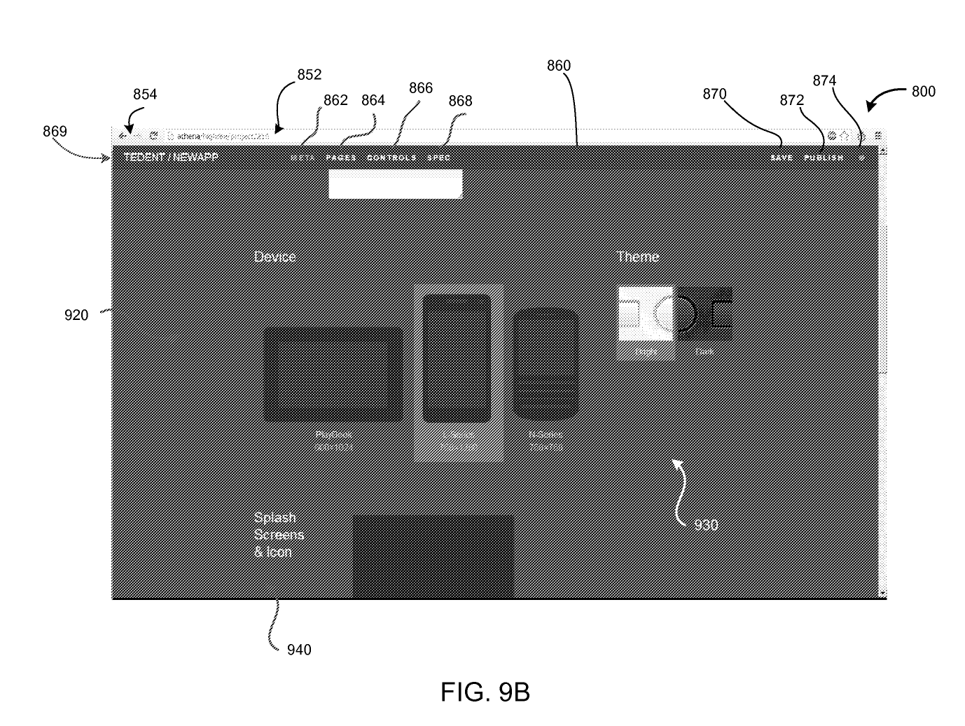

Scene graphs are common in many types of applications, such as complex UI applications and games and make it easier to manage complex arrangements of UI components. Using scene graphs can also increase the performance of applications. Finally, the hierarchical nature of scene graphs fits well with the parent/child relationship structure of Qt objects. For example, the code for a Container with two Button controls can be presented by the following and illustrated by the scene graph in FIG. 7.

```
Container {
  Button {
    text: “Button 1”
  }
  Button {
    text: “Button 2”
  }
}
```

Scene graphs can be useful to keep track of how object ownership might affect various aspects of an application. For example, a scene graph can be used to visualize how touch events are delivered to different controls on the screen.

### Object Ownership in QML

In QML, object ownership is established automatically according to the structure of the QML code of the application. For example, consider the above-noted code sample which creates two Button controls and adds the controls to a Container. The Container is the parent of the buttons and the buttons are children of the Container. When the container is destroyed, both buttons are destroyed as well.

### Object Ownership in C++

In C++, object ownership is a somewhat more complicated. Initial object ownership CaO be established either when controls are created or when the controls are added to other controls. Both approaches result in the same parent/child relationships, so either approach CaO be used in an application.

After object ownership has been established, the parent of an object can be changed by simply by adding the object to a different parent. The object is removed from the first parent and added to the new parent and the new parent then owns the object. An object can also be removed from a container without specifying a new parent for the object. However, this can present issues because even though the object has been removed from the container, the container is still the parent of the object and still owns the object. If the container is deleted, the object will be deleted as well. This can lead to errors in an application may be difficult to recognize.

When an object is removed from its parent, or when an object is replaced by a new object (in the case of certain setter functions, such as Page::setContent( )), it is removed from the visual hierarchy (i.e., it is not displayed on the screen anymore). The object's parent still owns the object, though an object can be re-parented or deleted at this point. If the object is not re-parented, it is still deleted when the parent object is deleted. However, an object cannot be re-parented if it is still part of the visual hierarchy of its parent. The object needs to be removed before it can be re-parented.

All QObject instances include a function called setParent( ) and this function can be used to re-parent an object when allowed, as described above. Using setParent( ) to re-parent an object does not add that object to the parent's visual hierarchy—it still needs to be added explicitly, for example, by calling Container::add( )). To prevent an object from being deleted when its former parent is deleted, a call to setParent(0) can be added after an object is removed from its parent.

There is an exception to the rules of object ownership. The top-level scene in an application, which is the AbstractPane object that is set as the root node using Application::setScene( ), behaves differently than other scenes/panes. The application takes ownership of the AbstractPane only if the pane does not already have a parent. If the AbstractPane does not have a parent when setScene( ) is called, the application will own the pane and will delete it if a new scene is set. However, if the AbstractPane already has a parent the application will not take ownership of the pane when setScene( ) is called.

This behavior lets an application switch between different scenes but still ensures that for the most basic use case (an application with just a single scene) the old scene is deleted when appropriate. If the application is to switch between two scenes, the parents of the AbstractPane objects should be set explicitly using setParent( ) before setScene( ) is called.

Many other functions of the Cascades™ application framework classes change the ownership of objects. The API reference for the classes and functions in application should be checked to ensure that object ownership is not altered in unexpected in ways

### Thread Support

Qt provides support for threaded applications with the QThread class. The ability to create new threads is often necessary if an application contains resource-intensive processes that would otherwise block the UT thread. A QThread represents a separate thread of control within the application; it can share data with all the other threads within the application, but executes independently in the same way that a standalone application does. In order to facilitate communication between threads, signals and slots are fully supported.

To use the QThread class, it is recommended to create a worker object derived from QObject and implement a slot on that worker to handle the task. The worker should also specify a signal that is emitted when the task is finished and an optional signal that is emitted when in case of an error. Once the worker class is created, QThread can be given ownership of the worker, the appropriate signals and slots can be connected, and the thread CaO be started.

### Application Development Tool

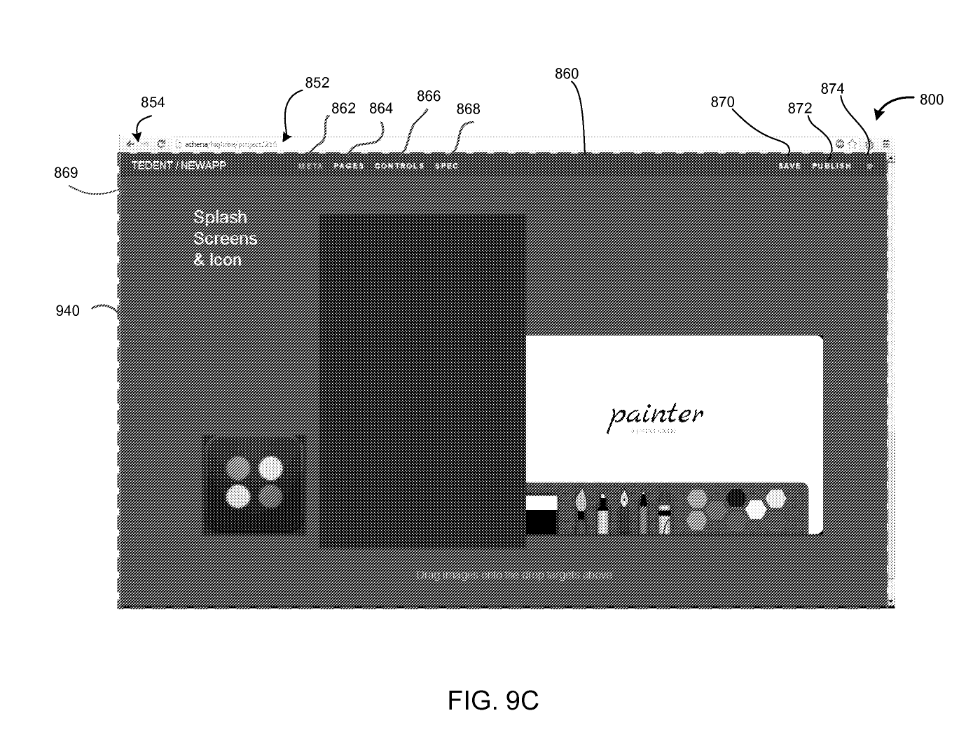

Referring now to FIGS. 8 to 12, a Web-based application development tool (tool) 800 in accordance with the present disclosure will be described. FIG. 8 shows an editor user interface screen of the tool 800 which acts as the editor user interface. The editor user interface screen allows individual application pages to be created and edited. Each application comprises a series of one or more pages which are displayed on the display 312 of a mobile device 130. Each application specifies the content and interaction between the pages. The tool 800 provides a visual user interface having a variety of tools for creating and editing applications for mobile devices 130 running a supported operating system 378. In the described embodiment, the tool 800 provides an interface for rendering and displaying applications for use the Cascades™ application framework for the BlackBerry™ 10 operating system, as well as creating and editing such applications. The tool 800 also causes application code in accordance with the Cascades™ application framework to be generated during saving, exporting or publishing of the application. The descriptive nature and properties of Qt and the Cascades™ application framework facilitates the use of a visual tool such as that provided by the present disclosure, which brings drag and drop functional to visual object creation, change and deletion in a manner which supports real-time collaboration development and “always-save” functionality. Nevertheless, it is contemplated that the tool 800 could be adapted to generate application code for use with a different application framework in other embodiments.

The tool 800 is a Web-based application which is accessed using the Web browser 282 on a computer 120. The Web browser 282 includes an address bar 452 which, when viewing or editing an application, indicates the address of the application hosted by the application development server 110, navigation buttons 854 and other controls. A user accesses the tool 800 by navigating to the application development server 110, for example at its Internet address, logging in to the application development server 110 using provided user credentials (user name and password), and requesting that a particular application under development which is hosted by the application is opened with the tool 800. Users can also register for a new account if they do not already have an account. These operations are implemented using communication protocols, such as HTTP/HTTPS communications, well known in the art.

As noted above, the tool 800 stores the application state in its own internal format on the client (e.g., computer 120). The tool 800 transcodes the QML document into JavaScript to create a hierarchy of JavaScript objects which correspond to the QML objects of the QML document using a JavaScript QML parser. The details of the transcoding need not be described for the understanding of the present disclosure. After transcoding, the computer 120 may discard the QML data. The current state of the application is maintained in memory by the computer 120 in JavaScript. In contrast, when the application is published to a mobile device 130, QML documents are processed natively with the provided QML parser.

The UI rendering engine on the computer 120 transcodes the JavaScript objects into HTML (HyperText Markup Language) objects styled using CSS (Cascading Style Sheets) so as to resemble Cascades™ UI controls written in QML. The JavaScript engine then inserts these stylized HTML objects into the active HTML page (document) and positions the UI controls with the HTML page using CSS in a manner similar to how the Cascades™ UI rendering engine would position the UI elements on a deployed mobile device 130. The transcoding operations allow the processing of a Cascades™ application in QML to be emulated within the Web browser 282 on a computer 120 which is not capable of natively processing the QML documents of the application and/or which does not support the Cascades™ application framework. It is contemplated that in other embodiments, QML documents could be processed using a combination of languages or technologies other than JavaScript, HTML, and CSS. The computer 120 causes QML application code in accordance with the Cascades™ application framework to be generated from the internal format (e.g., JavaScript) stored on the computer 120 when saving the application, exporting the application or publishing of the application to a mobile device 130. The computer 120 generates the full application code in its current state (if not already in memory), transcodes it from JavaScript to QML, and sends the QML to the ADS 110 when the application needs to be saved, exported or published to a mobile device 130. At least some of the metadata, such as the version number, associated with the application is typically exported with the application and included with the application when published to a mobile device 130. Once the application is published to a mobile device 130, the application communicates with the ADS 110 in the same or similar manner as the tool 800 with a Web browser 282 on a computer 120.

The tool 800 includes a canvas 810 in which a real-time rendering of an application under development is provided. The canvas, in the described embodiment, displays a rendered page 812 of the application. Different pages of the application can be rendered and displayed as the user navigates through the application pages activating the appropriate option in a control panel 860. Creating a new page displays a blank page and selecting an existing page causes the selected page to be rendered and displayed in the canvas 810. The canvas 810 may display gridlines or rulers other reference markings depending on the setting and may highlight a currently selected object.

The tool 800 includes a drag-and-drop object palette 820 which includes a number of objects including control UIs. The objects include core control UIs 822 which are defined by the Cascades™ application framework and Qt, such as a Button, CheckBox, ToggleButton, Slider, Label, TextField and ImageView, and optionally one or more custom control UIs. Objects from the object palette 820 can be added to the active (current) page of the application which is rendered and displayed in the canvas 810 by dragging and dropping the desired object from the object palette 820 to a desired location on the canvas 810.

When an object in the canvas 810 is selected, the tool 800 provides an attributes panel 830 which includes a number of attributes 832 for a selected object. The particular attributes 832 are context sensitive and depend on the type of the object which is selected. Similarly, the value of the various attributes 832 depend on the particular object which is selected. In the illustrated example of FIG. 8, a slider is selected so the attributes panel 830 displays attributes associated with slider. The attributes 832 for the slider include the object type, the object name, minimum, maximum and initial values for the slider, alignment properties, dimensions, padding and margins, among other properties. Similarly, the value of the various attributes 832 correspond to the selected instance of the slider.

As noted above, the particular attributes 832 are context sensitive and depend on the type of the object which is selected. A TextField, for example, may include attributes 832 for font, font size, italicization, bolding, and other visual highlighting.

Other possible attributes 832, such as visual attributes, may include whether the object is visible, opacity, scale, rotation from a default position, and the like. Other possible include attributes 832 may include audio properties. Some objects can have animation properties which, for example, can define transitions which can describe when and how an object moves, appears and disappears, rotates, or changes in size.

Some attributes 832 of an object not be locked and unavailable for modification by the user. The locked attributes have the associated values “greyed out” or otherwise displayed in a manner to indicate that the attributes are currently locked and cannot be changed.

It will be appreciated that the drag-and-drop object palette 820 and attributes panel 830 may include too many elements to display on the screen at the same time. In such instances, a scrollable panel or page is provided by the Web browser 282.

The tool 800 also includes a control panel 860 which includes control tabs for navigating between different pages of the tool 800. The control tabs include Meta tab 862 for displaying a Metadata user interface screen for setting and editing application information, device, orientation, splash screens, etc., a Pages tab 864 for displaying and editing application screens/pages, a Controls tab 866 for displaying, creating and editing custom UI controls which can be reused, and a Spec tab 868 for displaying a Specification user interface screen to review and document each of the Pages and Controls in the application.

While not typically part of the control panel 860, the editor user interface screen also includes a tab 871 for creating a new page and one or more tabs 873 (only one of which is shown in FIG. 8) for selecting a different existing page. While not shown in the described embodiment, the control panel 860 could also include navigation buttons for navigating between pages of the application. The control panel 860 also includes a Save button 870, a Publish button 872 for publishing an application to a test device, a Connection Indicator 874 which indicates whether there is an active connection to a test device to which the application has been published. The Connection Indicator 874 is green when active connection exists and is red when active connection does not exist. The control panel 860 may also include a Save Indicator (not shown) which indicates whether all current changes in the current session have been saved. The Save Indicator is displayed has a first appearance when the current state of the application has been saved and is displayed in a second appearance different from the first appearance when current state of the application has not been saved.

Incremental changes made by each user having authorization to edit the application between saves are automatically stored even if the current state of the application has not been explicitly saved. The incremental changes are stored in the form of the change information associated with these changes. The change information for each incremental change, described more fully bellow, includes the type of change, the changed node (i.e., the changed user interface object or control), a timestamp which specifies the date and time of the change, the user who made the change, and information or instructions to apply and reverse the change. Saving the application, for example using the Save button 870, saves the application state at a specific state of development. Applying the incremental changes since a previous save point, if any, results in the current state of the application. The tool 800 can at any time, in response to instructions of a user, apply the instructions for reversing a change or a series of changes to restore the application state from the current state to a previous state, which may be an explicit save point or an intermediate point which represents one or more incremental changes from an explicit save point.

The tool 800 may automatically save the status of the application in response to designated types of changes. The designated types of changes for automatically saving the application may include one or more of publishing the application to a mobile device 130 (e.g., for testing) connected to a client device or the ADS 110, exporting the application in QML for input on another client device, or occurrence of a particular type of change (such as creating a new page or custom control, etc.). The designated types of changes may also include a change in the metadata of the application (such as the version number), start/stop of a user collaborating on an application and/or possibly others.

The application code representing the state of the application at explicit save points and incremental changes between save points are stored separately by the tool 800, for example, in separate database tables in memory (electronic storage) managed by the ADS 110. The database tables may be in common memory managed by the ADS 110. The memory is also used to store media assets, such as digital still images and possibly digital video used by the applications and information about the applications developed using the tool 800. The memory may be distributed among two or more physical storage devices, which may or may not be geographically distributed, depending on the embodiment. The memory could be located, for example, in internal memory 114 of the ADS 110.

The information about the applications which is stored includes save information about the various save points, such as a timestamp which specifies a date and time of the save, and the user who made the save. As noted above, the change information includes the type of change, the changed node (i.e., the changed user interface object or control), the timestamp, the user who made the change, and information or instructions to apply and reverse the change. The information required to reverse the change depends upon the type of change, examples of which are described more fully below. The change information may include some or all of the application code associated with the change, depending on the type of change and/or the specific data which is being changed.

The incremental changes which are stored also include changes to the metadata describing the application which is displayed in the Metadata user interface screen. The changes to the metadata which are stored may include, for example, version changes, author changes, dates and times at which users start or stop collaborating on the application, changes to application properties, changes to device properties, etc.

Examples of the types of changes which can be made include, but are not limited to, object creation, object deletion, object modification, page creation, page deletion, page modification, and application modification. The change information associated with various types of changes in accordance with one embodiment of the present disclosure is provided below:
(1) Node Added: the change information includes the name of the QML document that the node was added to, the unique identifier of the new node (unique within the QML document), the type of the new node (e.g. Button, Label, TextArea, etc.), the unique identifier of the new node's parent (i.e., the node that the new node was added to), and the index of the new node within the parent's list of child nodes;
(2) Node Deleted: the change information includes the name of the QML document that the node was deleted from, the unique identifier of the deleted node, the unique identifier of the deleted node's parent (before it was deleted—so it can be reinserted by a rewind/undo operation), the index of the deleted node within the parent's list of child nodes (before it was deleted—so it can be reinserted by a rewind/undo operation), and the QML code for the deleted node (in its state immediately before deletion—so it can be reconstructed by a rewind/undo operation);
(3) Node Moved: the change information includes the name of the QML document that contains the node, the unique identifier of the moved node, the unique identifier of the new parent of the node, the index of the node within the new parent, the unique identifier of the old parent of the node (so it can be moved back by a rewind/undo operation), and the index of the node within the old parent's list of children (before it was moved—so it can be moved back by a rewind/undo operation);
(4) Node Changed: the change information includes the name of the QML document that contains the node, the unique identifier of the node, the name of the QML attribute that was changed (e.g. text, opacity, etc.), the new value of the QML attribute (which could be a string, a number, a function definition, etc.), and the old value of the QML attribute (so it can be changed back by a rewind/undo the operation);
(5) QML Document Created: the change information includes the name for the QML document (unique within the application) and the type of the new document (e.g. Page, Container (for custom controls), etc.);
(6) QML Document Deleted: the change information includes the name of the QML document and the QML code for the deleted document (in its state immediately before deletion—so it can be reconstructed by a rewind/undo operation);
(7) Active QML Document Switched: the change information includes the name of the QML document that is now in the foreground within the tool 800, the name of the QML document that was previously in the foreground within the tool 800 and the unique identifier of the user who changed documents (so that a connected mobile device can change the foreground document but other users working on the application can ignore this change);
(8) QML Documents Refreshed: the change information includes a list of QML documents (used when a custom control is modified and then the tool has to notify the other clients to update any pages that contain an instance of the custom control);
(9) File Uploaded: the change information includes the name of the file, the directory of the file (possibly determined based on the file type), and the type of the file (e.g. image, XML document, etc.);
(10) File Replaced: the change information includes the name of the file, the directory of the file (possibly determined based on the file type), and the type of the file (e.g. image, XML document, etc.), and information about the old file such as a copy of the old file (in its state immediately before being replaced—so it can be replaced by a rewind/undo operation); and
(11) File Deleted: the change information includes the name of the file, the directory of the file and information about the deleted file such as a copy of the old file (in its state immediately before being replaced—so it can be reconstructed by a rewind/undo operation).

The storage of save points and incremental changes along with the change information allows a fine grained rewind/undo capability in which each change to the application can be reversed or undone. Any previous application state can be rebuilt from a previous save point and applying all of the subsequent incremental changes. Furthermore, the sending of incremental changes rather than the full application code provides a lightweight “always-save” functionality similar to “autosave” in which the ADS 110 saves all of the incremental changes made to the application.

When an object is added to the canvas 810 from the object palette 820, e.g. using a conventional drag-and-drop operation, the application state is automatically updated to add the object at the current page of the application and at the onscreen location. As noted above, in the described embodiment, when operated on a computer 120 the tool 800 stores the application state in its own internal format, such as JavaScript, the details of which need not be described for the understanding of the present disclosure. The application code for execution on a target device in QML, or possibly C++ or a combination of QML and C++, is generated and output when required, such as when the application is published, exported or saved. However, in other embodiments, the tool 800 could generate and output application code in any suitable programming language or format, such as Java™, JavaScript, HTML, XML (Extensible Markup Language), CSS, Flash or a suitable combination thereof.

The attributes of a new object may be undefined or set to a default value, depending on the type of object and the attributes 832. The attributes of the selected (e.g., active) object can be edited by changing or manipulating a corresponding field in the attributes panel 830. When the value of an attribute of an object in the page is changed (e.g., size, position, etc.), the change is immediately reflected in any affected object in the canvas 810 as appropriate and the application state is automatically updated to reflect the changed attributes. For example, if the font of a TextField is increased by changing the font size property value in the attributes panel 830, the text in the text box appearing in the canvas 810 is displayed in a larger font size as soon as the value is changed in the panel 830. The changes are typically stored in association with name or other unique identifier (ID) of the user which made the change (user name or ID), and the timestamp of the change. Conversely, if an object is manipulated in the canvas 810 (e.g., resizing or repositioning of the object within the page), any affected attributes (e.g., size, position, etc.) are automatically updated in the attributes panel 830 and the application state is automatically updated to reflect the changed attributes.

The state of the application is updated on client devices in real-time or near real-time. To obtain a real-time or near real-time changes in the state of application, the client requests the current state of the application from the ADS 110. The client receives the application code in accordance with a previous save point from the ADS 110 along with any incremental changes, renders the user interface in accordance with the received application code, and applies any incremental changes that occurred since the previous save point in the order in which the changes occurred to construct the current state of the application. The client then requests further incremental changes to the application and applies further incremental changes when received from the ADS 110. The client and server interact in the same way to provide a real-time or near real-time copy of the application regardless of whether the client is viewing a single application (e.g., in the editor user interface) or a number of applications (e.g. showcase user interface).

An example implementation of a method for detecting and reporting changes to applications which a user has access to using the tool 800 will now be described. Each application which a user has access to is identified using, for example, an application identifier (ID). Comet may be used when the persistent connection between the clients and ADS 110 is a HTTP or HTTPS connection so that the ADS 110 can “push” data to a Web browser of a computer 120 or (Web) application on a mobile device 130 without an explicitly request for the data. Comet, also known as two-way-web, HTTP Streaming and HTTP server push among other names, may use one of multiple techniques which rely on features included by default in most Web browsers such as JavaScript and which is a common or easily incorporated feature of an application on a mobile device 130.

Specific methods of implementing Comet fall into two major categories: streaming and long polling. Each client may have an open GET request which requests recent changes from the ADS 110. Using an open GET request each client connected to the ADS 110 sends a GET request to the ADS 110 and expects it to remain open until there is a change to the application. When a change in the application is detected by the ADS 110, the ADS 110 responds to the GET request with the details of the change, the client applies the change to rendered user interface, and then the client sends a new GET request to the ADS 110. This process is repeated by each client while connected to the ADS 110. The use of an open GET request or other Comet technique provides a lightweight and straightforward implementation for detecting changes to the application state stored by the ADS 110 and reporting the changes to clients. Alternatively, a web socket or other similar technology could be used or the client could poll the ADS 110 for recent changes periodically.

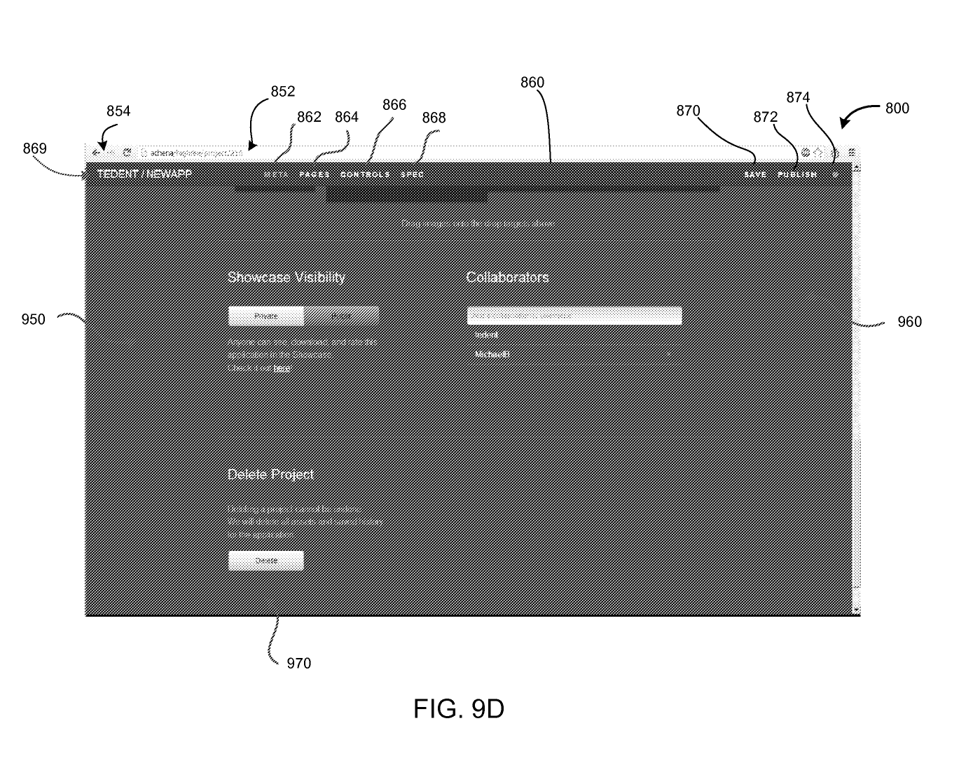

Referring now to FIGS. 9A to 9D, a Metadata user interface screen of the tool 800 in accordance with example embodiment of the present disclosure will now be described. The Metadata user interface screen provides a visual user interface for setting application properties and is displayed in response to selecting the Meta tab 862 described above. The Metadata user interface screen, based on the content and display configuration in the illustrated embodiment, is too large to be displayed within one screen of the Web browser 282 so a scrollable page is provided by the Web browser 282. In particular, three screens are required to display all of the Metadata user interface screen, although in other embodiments more or less screens may be required or the entire Metadata user interface screen could be displayed in a single screen.

The Metadata user interface screen displays information, settings and other properties relating to the application, many if not all of which can be set or changed by a user. The Metadata user interface screen includes a configuration section 910 in which application information such as the application name, author, version number and description can be set. The configuration section 910 also includes settings for preferred orientation, rotation options specifying whether the screen is permitted to rotate in accordance with device orientation, an entry point in the form of a page of the application at which the application is launched, a store display option for setting one or more images to be displayed in an application store (either the entry point or a one or more splash screens in the shown embodiment), as well as an export option for exporting the application code.

The Metadata user interface screen includes a device section 920 (FIG. 9B) which allows a device configuration to be selected from one or more supported mobile devices 130. The device section 920 which CaO include device names, device information and/or graphical representations of the mobile devices 130. In the illustrated embodiment, the following device configurations are possible: a tablet having a touchscreen, a smartphone having a touchscreen, and smartphone having a touchscreen and a keyboard, each having different screen sizes/shapes (e.g., aspect ratio) and possibly display resolutions.

When a device configuration is selected from the device section 920, device information regarding the selected device is propagated throughout the application. The page and its controls are re-rendered at a new screen orientation (canvas size) which corresponds to the newly selected device configuration. In the described embodiment, the generated application code does not contain any information about the target device although this may differ between embodiments. If the application code did contain information about the target device, the application code could be automatically updated to reflect the device configuration as required. Propagated device information may include, for example, display size, pixel density, display resolution, preferred orientation and the rotate option.

When a new application is created, the default page size (aspect ratio) and orientation will correspond to the screen size, screen resolution, and preferred orientation of the selected device configuration. If the device configuration is changed, the screen size, the default page size and preferred orientation of the new device configuration is propagated to all the pages of the application. The attributes of existing objects affected by these device properties in the application code are automatically updated, for example, by changing size, layout and rotation values, such that the object is properly sized, positioned and oriented for the new device configuration.

Other device configuration information which may be selectable in the device section 920 and which may be propagated through the application includes also information regarding other input or output devices, such as if the device has a physical keyboard, an orientation sensor, a proximity sensor, a motion sensor, a camera, a GPS, audio devices, lights, buzzers, wired or wireless communication capabilities and the like. Device information can also include processor type, memory size, operating system information, vendor, compatible programming language, available software modules and the like. It will be appreciated that the supported mobile devices 130 may vary based on the application framework implemented by the tool 800.

It is contemplated that some object attributes may be device specific and may not change when the device configuration changes. This may allow nuances of a particular device to be maintained even when developing an application for use on different mobile device configurations. It is also contemplated that some object attributes may be locked for an application so as to be common across all device configurations.

The Metadata user interface screen includes a theme section 930 (FIG. 9B) for selecting a theme. By selecting a theme, attributes associated with that theme such as colour schemes, fonts, layouts, and the like, can be propagated to appropriate object attributes throughout the application. In the shown example, a light theme and a dark theme are shown. However, other themes may be shown in other embodiments.

The Metadata user interface screen includes a splash screens and icon section 940 (FIG. 9C) for setting one or more splash screens to be displayed during the boot-up or launch of the application and an application icon to be displayed in an icon menu of home screen or other screen of a device upon which the application is installed. The splash screens and application icon are represented by dark grey boxes. “Hint” text explaining the respective function of the boxes may display in response a hover on an onscreen position indicator (e.g., pointer). The hints may be displayed towards the vertical middle of the screen. A developer or designer can drag and drop images onto the disabled boxes, or otherwise select images to set the application icon, horizontal splash screen for a horizontal screen orientation, and vertical splash screen ford vertical screen orientation. The source images may be stored locally, for example on a local hard disc drive, or remotely.

The application icon box expects a square image (and has a square drop target). The application icon is typically displayed on the home screen application icon menu as well as an application storefront (which is outside the scope of the present disclosure). The icon source image is PNG and the Splash Screens are PNG or JPG/JPEG in the described embodiment, but could vary in a different embodiment.

The Metadata user interface screen includes a visibility section 950 (FIG. 9D) for viewing and setting whether the application is private or public. Private applications are only accessible by authorized users (i.e., collaborators described below), whereas public applications are accessible to all users of the application development server 110. This allows, for example, applications under development to be viewed by all users of a particular enterprise.

The Metadata user interface screen includes a collaborator section 960 (FIG. 9D) for viewing and setting users who have authorization to view and edit the application, known as a collaborators. The Metadata user interface screen includes a delete section 970 (FIG. 9D) for deleting an application from the application development server 110.

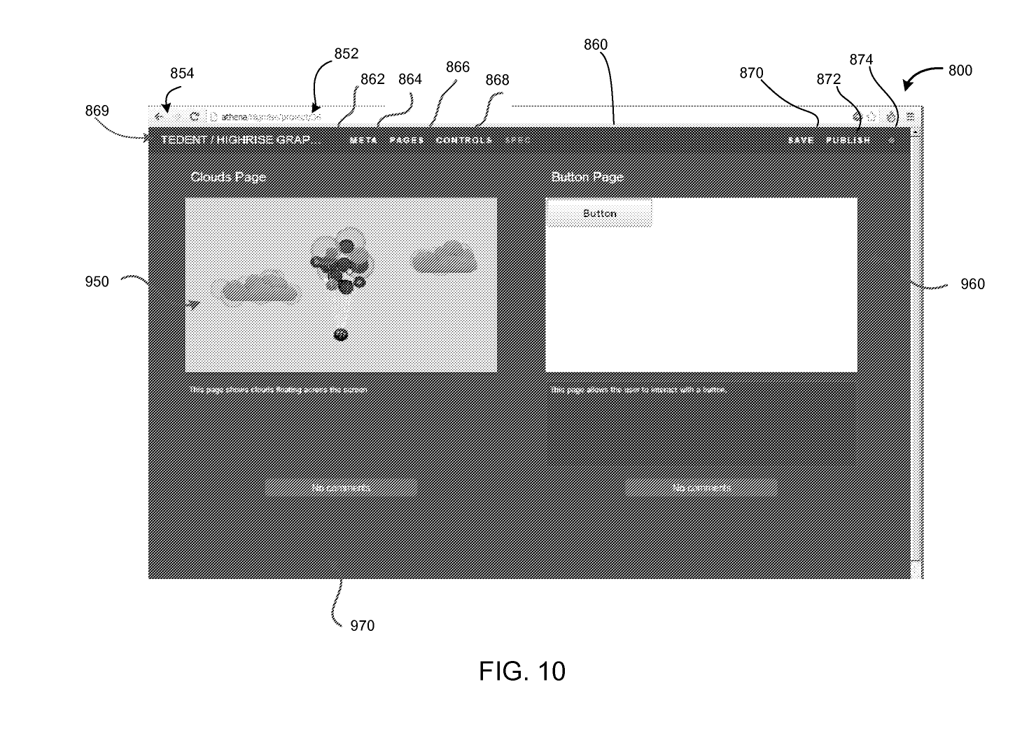

Referring now to FIG. 10, a Specification user interface screen of the tool 800 in accordance with an example embodiment of the present disclosure will now be described. The Specification interface screen is displayed in response to selecting the Spec tab 868 described above. The Specification user interface screen shows a grid of all the pages (screens), panes, and controls in the application. Pages, panes and controls are all the individual document files which become QML files when exported. The Specification user interface screen renders each of the documents in a single page along with a few editable fields which a developer or designer can use to document the files. This gives developers and designers a way to provide some metadata about each file, such as its purpose. For example, “Title: Application Login Page. Description: This page is shown when the application is launched and the user has not previously logged in.” The Specification user interface screen is meant to be a digital form of a “Specification document” that would typically be created in a non-development environment which can be printed and shared or discussed. In a different embodiment, the Specification interface may also include a user interface area for comments or discussion around the application, and/or user interface areas for comments or discussion around each of the application pages.

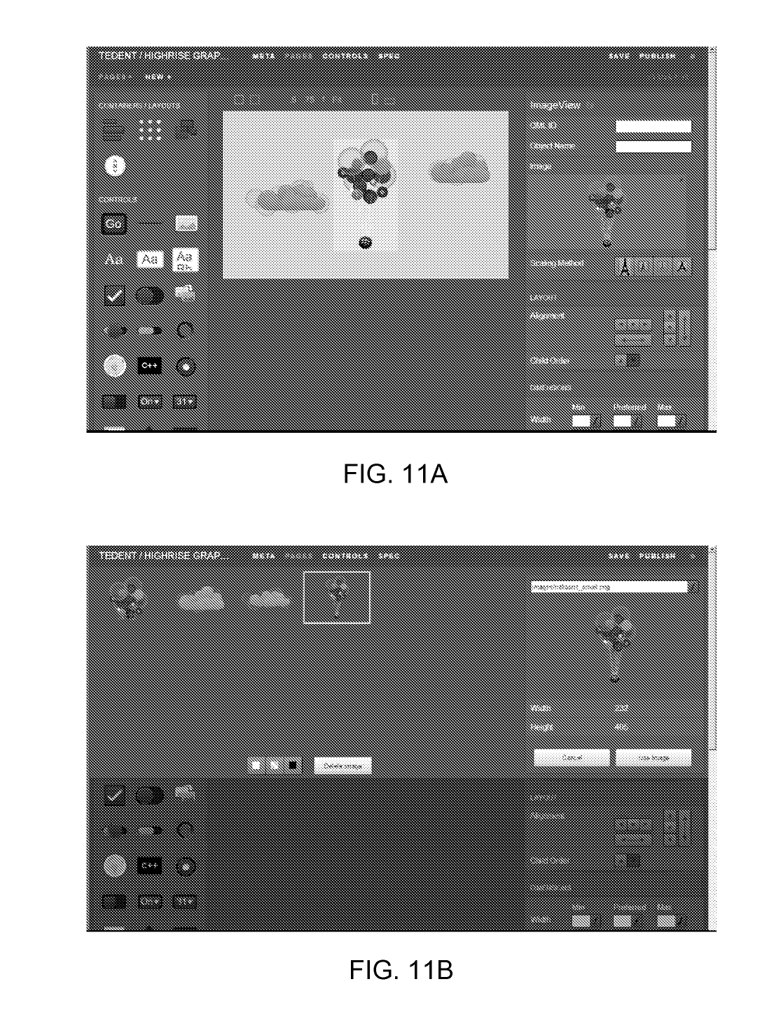

Referring now to FIGS. 11A and 11B, an Image user interface screen of the tool 800 in accordance with example embodiment of the present disclosure will now be described. The Image user interface screen provides a list of all the image assets that have been imported into the application. When an image control in an application displayed in the editor user interface screen is selected (see FIG. 11A), such as an Image View, an option to invoke the Image user interface screen, sometimes referred as the Image Picker, is provided. The option may be provided, for example, by clicking on an area in the attributes panel 830, or in a context-sensitive menu which itself may be invoked by a right-click of a mouse or other pointing device on the computer 120 or other input. Alternatively, the Image user interface screen may be displayed in response to selecting an Image tab (not shown) in the control panel 860 which is available when images are included in the application. As shown in FIG. 11B, the Image user interface screen provides a visual interface to select, delete, review and change the properties (e.g., background colour) of image assets in the application.

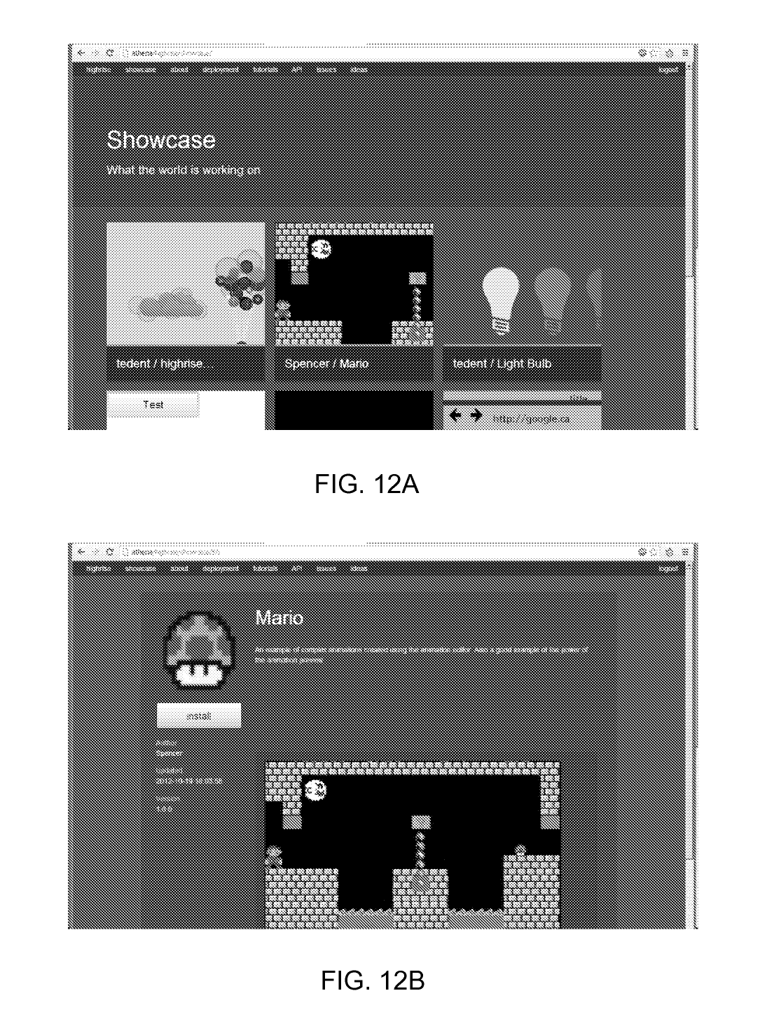

Referring now to FIGS. 12A and 12B, a Showcase user interface screen for viewing community applications in accordance with example embodiment of the present disclosure will now be described. All applications managed by the tool 800 are developed and stored on the application development server 110; however, not all applications are publicly visible. A developer or designer must choose to share their application with the community in order for other users to view the application in a community “Showcase” user interface screen, an example of which is shown in FIG. 12A. The community Showcase user interface screen displays application information for one or more applications to which a user has access. An application name and one or more pages from one or more shared applications is rendered and shown in the community Showcase user interface screen. A user has access to applications created by the user, applications explicitly shared with the user, and public applications that all users can access. If an application is marked “public” in the visibility section 950 (FIG. 9D) of the Metadata user interface screen, the application is available in the Showcase user interface screen. The Showcase user interface screen can be used to display a number of applications at one time, display the changes being made to the applications as the changes happen in the same fashion as changes to a particular application the user is working on is shown, and can be used to display who is working on which applications in real-time or near real-time. This allows collaborators to preview some of the most recent changes to applications to which a user has access.

In the shown embodiment, a single page and the application name for each accessible application is displayed in a grid or array. The page displayed may be a last edited page or a designated page in the application, among other possibilities. In other embodiments, the application information can be displayed other formats including but not limited to a list format or a slide reel format. The application information displayed in the Showcase user interface screen may also include, for example, an application version number, description, author, edit dates/times, or any other application related information.

One, some or all of the pages of the application can be rendered in the Showcase user interface depending on the application (e.g., parameters in association with the tool, number of pages, etc.) or the tool 800 (e.g., settings). The rendered applications in the Showcase user interface screen can be sorted according to most recently created, or most recently edited or other criteria. The ADS 110 detects changes made to all of the applications which a user has access to. In the described example, changes are associated with a particular application using the application ID. When a change is made to one of the applications which a user has access to, the ADS 110 reports the change information in the client so that it can be applied to the corresponding page of the corresponding application shown in the Showcase user interface screen.

In the described embodiment, each client sends an open GET request to the ADS 110 for each application which the corresponding user has access to. As noted above, the application ID is used to identify the respective applications. When the ADS 110 detects a change to an application for which there is an open GET request, the ADS 110 responds to the GET request by sending to the client the change information corresponding to the change. The client then applies the change to rendered user interface. When the client is a computer, the change information may be transcoded from QML as described above if the received change information included QML code. Finally, the client sends a new GET request to the ADS 110 in respect of the changed application so that it receives further changes to the application. This process is repeated by each client while connected to the ADS 110.

The Showcase user interface screen may identify recently modified applications, such as the most recently modified application. For example, the application which has been most recently updated may be displayed at the top of the Showcase user interface screen. The page of the application may move or “bubble” of the top of the displayed pages of the applications in the Showcase user interface screen to bring the application in view, for example, if it was below the current page scroll. Alternatively, rather than changing the position of the application, the application may be bolded, flash, displayed in a different colour, or otherwise displayed in a manner that distinguishes the most recently updated application.

An identification of the user who is working in the application may also be displayed in the Showcase user interface screen in association with the page, for example, below the live-rendered page. Because the ADS 110 knows the last incremental change for each user and how long ago the change happened, the client 110 can accurately identify and display user avatars (or images) in association with the applications which users are working on.

In the shown embodiment, the number of shared applications is too large to display all of the live-rendered pages within one screen of the Web browser 282 (FIG. 2) so a scrollable page is provided by the Web browser 282 (FIG. 2). In the shown embodiment, the live-rendered pages are presented in a tiled or grid configuration. A different arrangement may be used in other embodiments. The live-rendered pages of the shared “community” applications may be a last edited page (e.g., changed or added page) or a designated page. In either case, the pages are live-renders based on the current state of the application.

As shown in FIG. 12B, a public application is accessible via a dedicated URL (uniform resource locator) and has a dedicated application page which may be displayed by selecting the application from the Showcase user interface screen, for example, by appropriately selecting the live-rendering of the application from the Showcase user interface screen or via the dedicated URL. The application page displays renderings of the application and shows some or all of the data from Specification user interface screen.

### Splash Screen and Application Image Creation

As noted above, the Metadata user interface screen includes a splash screens and icon section 940 for setting or creating one or more splash screens, showcase images and icons for an application that is being developed using the application development tool 800. As known in the art, splash screens are images displayed on a device to provide visual feedback while an application is being loaded or launched by the device. The splash screen associated with an application commonly displays one or both of company or application branding or information associated with the application. The splash screen may reflect an ultimate rendered state of a user interface of the application, however creating splash screens that reflect an application's rendered state can be a time-consuming and tedious exercise for an application developer. Additionally, the splash screen must be re-rendered each time an application is updated. As a result, application developers will often opt to limit the splash screen for an application to simply company or application logo/branding.

Accordingly, example aspects of the present disclosure relate to a method and system for facilitating the creation of splash screen images and other images for an application, including splash screens that reflect the rendered state of an application's user interface.

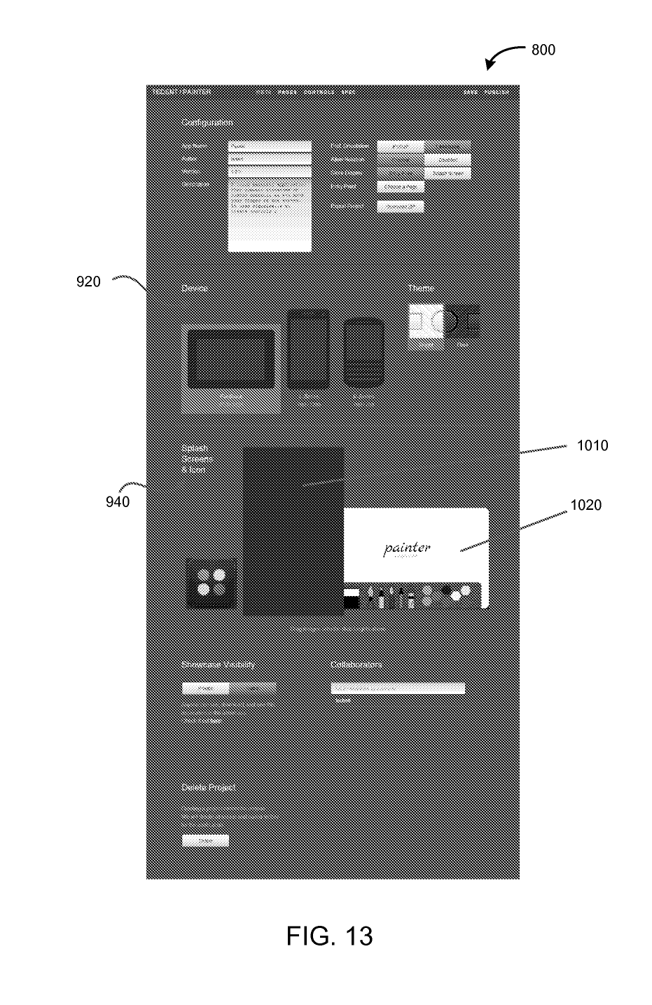

In this regard, FIG. 13 shows the entire Metadata user interface screen which was shown as parts in FIGS. 9A, 9B, 9C and 9D. The splash screens and icon section 940 can be used to assign different splash screens for different devices and for different display attributes for the application that is being developed. For example, in FIG. 13, a first splash screen 1010 can be set for use when the device is in a portrait orientation, and a second splash screen 1020 set for use when the device is a landscape orientation. Different splash screens can also be assigned for different devices or for different device attributes such as screen resolution.

In some examples, the Tool 800 can also provide an interface for assigning showcase, thumbnail or icon images associated with an application which can be used in application listings or in application stores.

In some example embodiments, the setting of the images used in a application's icons, splash screens or showcase images can be performed by manually selecting an existing file or drag-and-dropping an image into the appropriate section of the Metadata user interface screen.

Additionally, in the presently described embodiment, the images used to create an application's icons, splash screens or showcase images can alternatively be generated by a target device 130 that is of the same type or class of device that the application is ultimately intended to be run on. In particular, images from screen shots captured on a target device 130 can be used to set images associated with an application such as an application's icons, splash screens or showcase images. Capturing these screen shots on a target device 130 can provide accurate renderings of the application as they would appear on the device 130. In example embodiments, the Tool 800 provides a method for capturing a screenshot generated on a target device 130.

In an example embodiment, while a programmer is creating an application using Tool 800, the target device 130, which may for example be a device that belongs to or is used by the programmer, communicates with application development server 110. In one example, the applications 380 present on target device 130 include a function that enables the target device 130 to be authenticated with application development server 110 to establish a session during which the device 130 can be used by the programmer to receive and preview versions of the application that is under development. Thus, at various times during a development project, a programmer using Tool 800 on workstation 120 can cause the application development server 110 to publish the application under development to the target device 130 and preview the application operating on the target device 130.

According to example embodiments, when a session is established between application development server 110 and the target device 130 the developer can cause the application development server 110 to capture images from the target device 130 for future use in association with the application (for example as a splash screen, icon, showcase or thumbnail image).

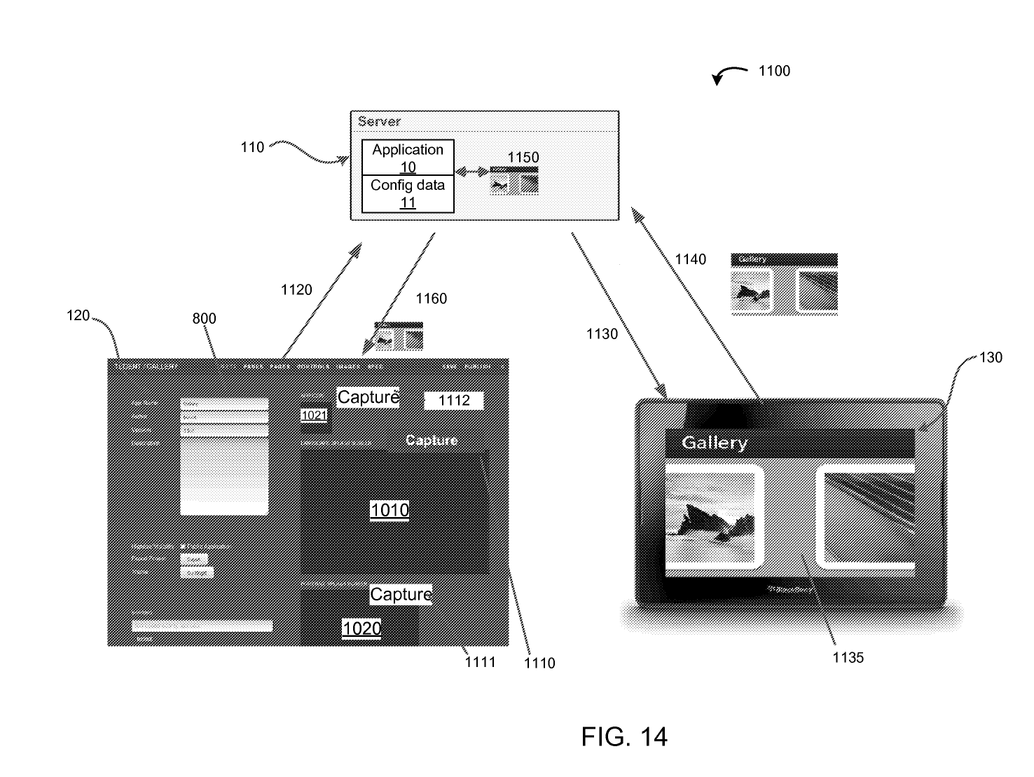

In this regard, FIG. 14 illustrates an example method 1100 of generating an image for use with an application based on a screenshot on a target device 130. In the example of FIG. 14, a developer is accessing web-based Tool 800 on workstation 120 to develop an application 10 on the application development server 110. The server 110 has established a session with a target device 130 that is associated with the developer and a development version of the application 10 has been downloaded to the target device 130. The development version of application 10 is running on the target device 10 in the foreground, displaying image 1135. In an example embodiment, the developer has placed the device 130 in the orientation that the developer desires for capturing the image 1135, and has caused desired content generated by the application to be displayed as image 1135.

In the presently described embodiment, the developer initiates capturing of the displayed image 1135 by performing an input action at workstation terminal 120. In this regard, in the example of FIG. 14, Tool 800 includes a first virtual “Capture” button 1110 associated with the landscape splash screen display region 110, a second virtual “Capture” button 1111 associated with the portrait splash screen display region 1020, and a third “Capture” button 1112 associated with the application icon display region 1021. In such case, an input action could include selection of the landscape “Capture” button 1110 (for example, by detection of a click or screen touch or other navigational input at the location of button 1110). As indicated by arrow 1120, the development server 110 receives notification from the developer's workstation 120 that an input action has been detected in respect of the of the landscape “Capture” button 1110. The development server 110 treats the notification of the input action as a trigger event for capturing the currently displayed content on the screen of the target device 130, and in this regard sends a capture screenshot command (represented by line 1130) to the target device 130, causing the device 130 to perform a screenshot of the image 1135 that is currently displayed on its screen. The target device 130 then sends the captured screenshot image data to the development server 110 as indicated by arrow 1140. The development server 110 then stores the screenshot data as an image file 1150. Tool 800 tags or otherwise associates the image file 1150 with metadata or a label that identifies the image file as the splash screen for a landscape orientation for the particular class or type of device that target device 130 belongs to for the subject application 10. In some example embodiments, the image file label or metadata could include one or both of the dimensions and resolution of the image 1135 as captured. The application 10 includes associated configuration data, for example a configuration document 11, that is updated to identify image file 1150 as a landscape splash screen file for the application 10.

As indicated by line 1160, the Tool 800 can display the screen-shot generated splash screen image 1135 in the landscape splash screen display region 1010 at terminal 120, providing the developer with real-time feedback as to what the splash screen image looks like. The developer has the option of changing the image displayed on target device 130 and repeating the exercise if they would like a different splash screen.

In an example embodiment, in order to set a portrait splash screen, the developer physically rotates the target device 130 to a portrait display mode, then selects the portrait splash screen capture button 1111 to repeat the process described above. Similarly, application icon image capture button 1112 allows the developer to selectively capture screen shot images from the target device 130 that are stored as image files at development server 110 with respective labels or metadata that associate the files with application 10.

Accordingly, the method described in respect of FIGS. 13 and 14 allows the development server 110 to capture and store screen shots from a target device 130 from a development version of an application 10 for use as images associated with the application 10 such as splash screen images, thumbnail images, showcase images and icon images. When the application is subsequently published or exported to a device, the configuration document 11 includes the names of the image files 1150 that have been set as the splash screen images, icon images, and other pre-rendered images associated with the application 10.

In some example embodiments some or all of the procedures of method 1100 can be automated. For example, in one embodiment, the view orientation is provided to the target device 130 as part of the capture screenshot command of action 1130, obviating the need for the target device 130 to be physically placed in the correct orientation. In such an example, when the landscape “Capture” button 1110 is selected, the server 110 is configured to send to target device 130 a capture screen shot command that includes an instruction for device 130 to display current image 1135 in landscape orientation regardless of the actual physical device orientation and then capture the resulting image as a screenshot. Similarly, when the portrait “Capture” button 1111 is selected, the capture screenshot command sent to target device 130 includes an instruction for device 130 to display current image 1135 in portrait orientation regardless of the actual physical device orientation and then capture the resulting image with a screenshot.

Further automation can occur in some examples in that the development server 110 can be configured to capture and store multiple screen shots for use by the application 10 in response one trigger event, for example selection of a single capture button such as button 1110. In this regard, in an example embodiment, upon the occurrence of a trigger event (for example selection of the “Capture” button 1110) the development server 110 is configured to send a screen capture request to the target device 130 that specifies a plurality of different views to capture of the currently displayed content, for example a landscape view, a portrait view, and a view suitable for an icon image. The target device automatically generates and screen captures the specified images and returns the respective image files to the development server 110 where the files are stored, labelled and referenced in the application configuration document 111. In some example embodiments where multiple images are being captured from the target device 130, the development server 110 is configured to automatically send out each screenshot request with a desired orientation and receive back the resulting image data one image at a time as opposed to a batch request.

In some example embodiments, the display screen of the target device 130 could have multiple possible portrait and multiple landscape orientations—for example the device may have a keyboard that slides partially over the display screen, or operate in modes where only part of the display screen is used to display a splash screen. In such situations, the development server 110 could be configured to automatically specify in the screenshot request sent to the target device 130 the screen dimensions and orientation for each screenshot.

In the embodiments described above, a developer manually causes a selected image from application 10 to be displayed on the target device 130 prior to selecting the splash screen capture button on workstation 120. However, in some example embodiments the selection of the image displayed on target device 130 can be automated in that the screenshot instruction sent by development server 110 to the target device 130 further includes information that specifies which application-related image is to be displayed on the screen of the target device 130 for the purposes of capturing the screenshot, and the target device 130 is configured to display the specified image with the specified orientation and dimensions for the screenshot. In some example embodiments, one or both of the workstation 120 and the target device 130 are configured to automatically ensure that the target device has the latest version of the application 10 installed, and if not, then install the latest application version prior to taking the specified screen shots.

In some example embodiments, during a development session multiple target devices 130 each having different screen configurations could be registered with the development server 110, and the development server 110 configured to send screen capture instructions to each of the respective target devices 130. The returned image files are logged in the application configuration document 111 and labelled by the development server as splash screen (or icon or other) images for the application 10 for the respective device orientations and screen dimensions.

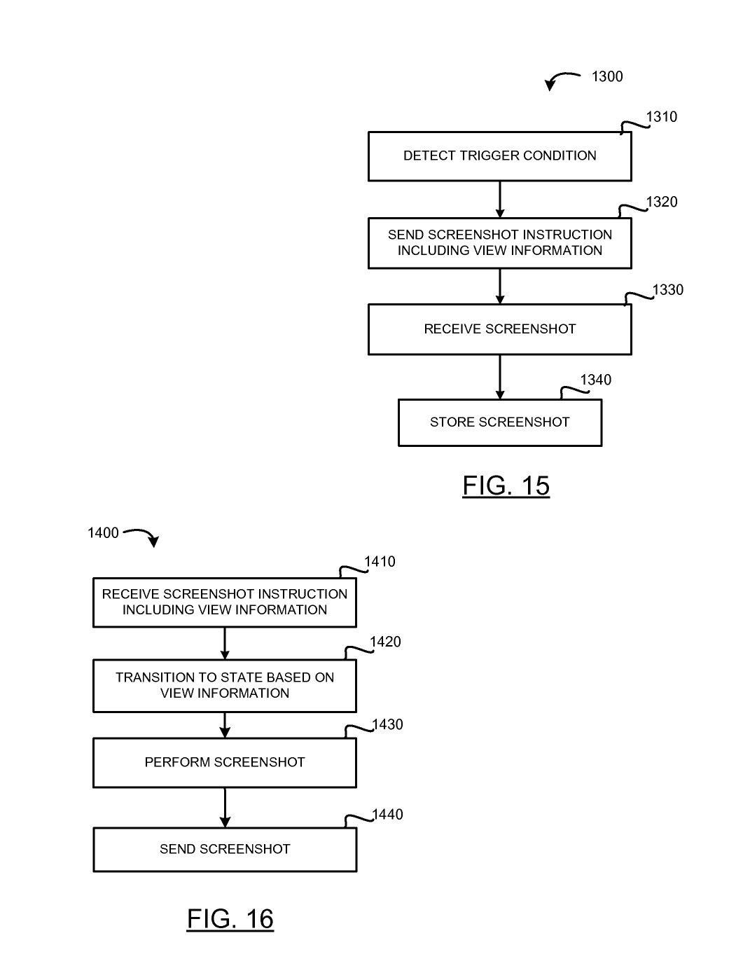

FIG. 15 shows a flowchart of one example of a possible set of actions 1300 carried out at development server 110, and FIG. 16 shows a flowchart of one example of a possible set of actions 1400 carried out at target device 130, to perform the method of FIG. 14. In at least some examples, the actions in FIGS. 15 and 16 are carried out while the target device 130 is in an authenticated development session with the development server 110. At action 1310, development server 110 detects a trigger condition for capturing a screenshot. As noted above, the trigger condition could for example be receipt of notification of selection of a “Capture” button 1110, 1111 or 1112 at workstation 120 requesting a screenshot for a one or more of a landscape or portrait splash screen, an application icon, a showcase image, or other application related image.

In some examples, a trigger condition could be detected at action 1310 when a change to a specified view of application 10 is detected. For example, a default setting may be to use a first page of application 10 as a splash screen. Accordingly, a trigger condition can include any change which affects the first page of the application 10. In some examples, the development server 110 may be configured to detect when the application page or view previously used to set a splash screen image or other image has been changed and treat that change as a trigger condition for acquiring new screen shots of the amended application page or view.

At action 1320, a screenshot command or instruction is sent by the development server 110 to the target device 130. As noted above the screenshot instruction can take a variety of different forms—in a basic example, the screenshot instruction merely includes an instruction to capture and return the current screen content; however, in other examples, the screenshot instruction may also specify required view information including one or more of image orientation, image resolution, image selection (for example a specified application page), image dimensions, or other information which affects a view of the application related image. In some examples, the screenshot instruction can include batch requests for multiple screenshots, with the view information specified for each of the screen shots—although in some embodiments actions 1320-1340 of action set 1300 could be carried out sequentially for each screenshot when multiple screen shots are required. As noted above, in some examples, screenshot instructions could be sent to a plurality of authenticated target devices 130. In some examples, the development server 110 could be configured to selectively send screenshot instructions to a specific target device 130 based on specified view information. For example, if a screenshot with a specific resolution is required, a target device having that native resolution or capable of displaying that resolution can be selected.

As indicated at action 1330, the development server 110 receives the one or more screenshot images back from the target device 130. As indicated at action 1340, each screenshot is stored as a pre-rendered image file 1150 and the configuration data 11 for the application 10 updated to reference the screenshot. Each saved image 1150 is labelled to indicate its type (for example: splash screen, showcase image, or icon for the application 10). The image label can also include, where appropriate, one or more of orientation information (for example: portrait, landscape), target device type, resolution or image dimensions.

Turning now to FIG. 16, target mobile electronic device 130 is configured to carry out set of actions 1400 in performing its part of the method of FIG. 14. While in an authenticated development session, the target device 130 listens for a screenshot instruction from development server 110. As indicated at action 1410, the target device 130 receives a screenshot instruction. As noted above, in a basic example, the screenshot instruction simply instructs the target device 130 to perform a single screenshot of its currently displayed content and return the captured image to the development server 110. However, in some examples the screenshot instruction includes view information such as information identifying one or more of a view or page of the application, a screen orientation, or a screen resolution for one or more desired images. In some examples, the screenshot instruction (or a previous instruction received from the development server 110) may identify an application version and the target device 130 will verify that it has the correct application version and download a copy (or updates) of the correct version of the application if required.

In a configuration where the screenshot instruction includes view information, as indicated at action 1420, the target device 130 transitions to the required display state based on the view information. This CaO include one or more of traversing an application to a requested view or page or setting an orientation or display attribute based on the view information.

At action 1430, the device 130 performs a screenshot of the image displayed on its screen. In some example embodiments, as an alternative to capturing content actually displayed on the screen of devices 130, a virtual screenshot may be performed by rendering an image that could be displayed on the device in a non-displayed screen buffer based on the view information, and using the virtually rendered image data as the screen capture.

At action 1440, the generated screenshot image data is sent to the requesting development server 110.

When the screenshot instruction received at action 1410 includes multiple views of the application to be captured, the actions of 1420, 1430, and 1440 can be repeated for each view.

In some example embodiments, activities that occur on workstation 120 could occur directly on application development server 110. In some example embodiments, target device 130 may communicate with development server 110 directly over a wired or wireless communications link rather than through communications network 150.

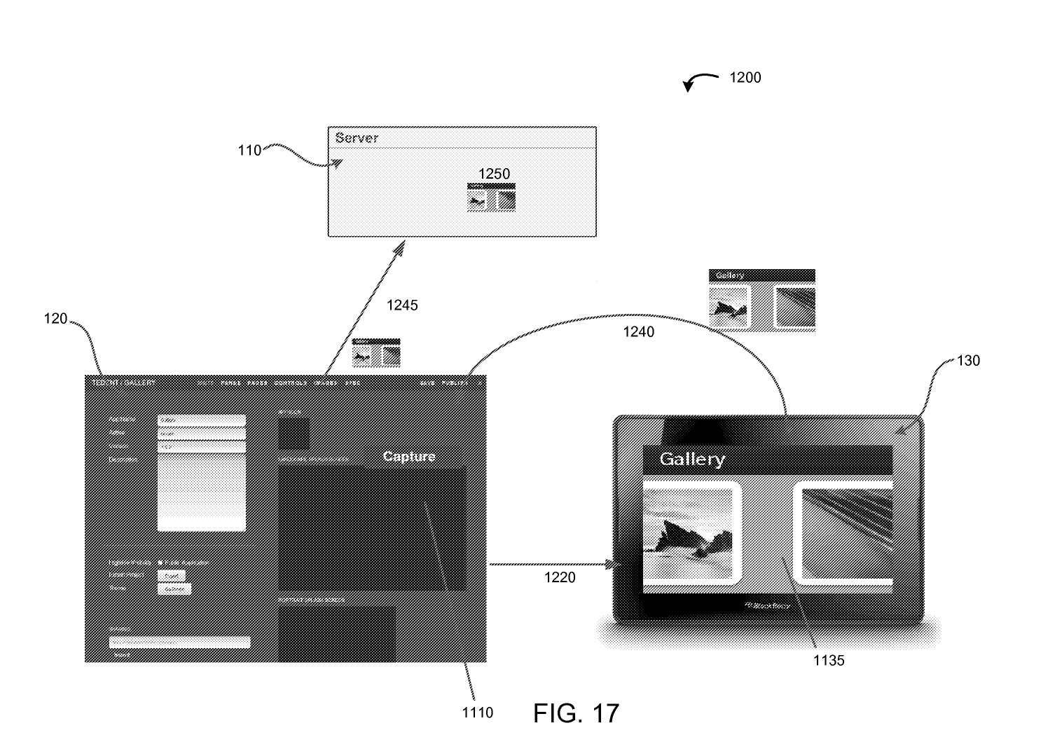

In some example embodiments, communications between the application development server 110 and the mobile device 130 could be at least partially routed through the workstation 120. For example, a direct wired link such as a USB cable, or a direct peer to peer wireless link such as a Bluetooth™ link between the target device 130 and the workstation 120 could serve as a conduit for communications between the server 110 and the target device 130. By way of example, FIG. 17 diagrammatically illustrates another example method 1200 of generating a screenshot on a target device which is similar to method 1100 except that the device 130 has a direct communications link with workstation 120. In this example, the workstation 120 sends screenshot instructions to the target device 130 as illustrated by arrow 1220 and receives the resulting screenshot as illustrated by arrow 1240. The screenshot image is then sent by workstation 120 to development server 110 for storing in association with application 10.

The applications and images files described in the above steps need not be stored directly in the application Server—for example, such information could be stored at one or more databases 142 or collaboration servers 140.

While the described embodiments relate to a Web-based integrated development environment and tool, the teachings of the present disclosure could be applied to a private network, such as a corporate or other enterprise network, to provide similar benefits within a private network environment.

The steps and/or operations in the flowcharts and drawings described herein are for purposes of example only. There may be many variations to these steps and/or operations without departing from the teachings of the present disclosure. For instance, the steps may be performed in a differing order, or steps may be added, deleted, or modified.

While the present disclosure is described, at least in part, in terms of methods, a person of ordinary skill in the art will understand that the present disclosure is also directed to the various components for performing at least some of the aspects and features of the described methods, be it by way of hardware components, software or any combination of the two, or in any other manner. Moreover, the present disclosure is also directed to a pre-recorded storage device or other similar computer readable medium including program instructions stored thereon for performing the methods described herein.

The present disclosure may be embodied in other specific forms without departing from the subject matter of the claims. The described example embodiments are to be considered in all respects as being only illustrative and not restrictive. The present disclosure intends to cover and embrace all suitable changes in technology. The scope of the present disclosure is, therefore, described by the appended claims rather than by the foregoing description. The scope of the claims should not be limited by the described embodiments set forth in the examples, but should be given the broadest interpretation consistent with the description as a whole.

1. A method of acquiring an image for an application, comprising:
sending a screenshot instruction to a target device upon detecting a trigger event;
receiving image data from the target device in response to the screenshot instruction; and
upon receiving the image data, automatically storing the image data and associating the image data with the application.

2. The method of claim 1, wherein the screenshot instruction includes information specifying one or more of an image orientation, an application page, an image resolution, or an image dimension.

3. The method of claim 2, wherein the screenshot instruction includes instructions for a plurality of screenshots, and receiving image data includes receiving data for a plurality of screenshots.

4. The method of claim 1, including labelling the image data for use as a splash screen or an icon for the application, and the screenshot generated at the target device is rendered by a version of the application operating on the target device.

5. The method of claim 1, comprising automatically sending a plurality of screenshot instructions to the target device upon detecting the trigger event, at least some of the screenshot instructions specifying different image orientations, and receiving image data comprises receiving image data for a plurality of respective images having the specified image orientations.

6. The method of claim 1, wherein the method is performed at an application development server, the screenshot instruction is sent to the target device through a communications network that includes a wireless link to the target device, and the trigger event includes receiving a signal from a remote workstation terminal indicating that a screenshot image is requested.

7. The method of claim 6, comprising, prior to sending the screenshot instruction, providing a version of the application to the target device, and authenticating the target device, wherein the image data received from the target device includes a screenshot of a page generated on the target device by the version of the application provided to the target device.

8. The method of claim 1, comprising establishing a first communication link between a workstation accessing a web based application development tool on an application development server and a second communication link between the workstation and the target device, wherein the screenshot instruction is sent to the target device via the second communication link and the image data is received by the workstation from the target device via the second communications link and then received by the application development server through the workstation via the first communications link and the image data is stored by the application development server.

9. The method of claim 1, wherein the application has associated configuration data, and associating the image data with the application includes updating the configuration data to reference a filename for a file storing the image data.

10. A system for developing applications for use on a mobile electronic device, comprising:
a communication interface;
a storage;
a processor configured for:
sending a screenshot instruction to a target mobile electronic device through the communication interface upon detecting a trigger event;
receiving image data through the communication interface from the target device in response to the screenshot instruction; and
upon receiving the image data, automatically storing the image data in the storage and associating the image data with the application.

11. The system of claim 10, wherein the screenshot instruction includes information specifying one or more of an image orientation, an application page, an image resolution, or an image dimension.

12. The system of claim 11, wherein the screenshot instruction includes instructions for a plurality of screenshots, and receiving image data includes receiving data for a plurality of screenshots.

13. The system of claim 10, wherein the processor is configured for labelling the image data as a splash screen or an icon for the application, and the screenshot generated at the target device is rendered by a version of the application operating on the target device.

14. The system of claim 10, wherein the processor is configured for automatically sending a plurality of screenshot instructions to the target device upon detecting the trigger event, at least some of the screenshot instructions specifying different image orientations, and receiving image data comprises receiving image data for a plurality of respective images having the specified image orientations.

15. The system of claim 10, wherein the processor is located at an application development server and the screenshot instruction is sent to the target device through a communications network that includes a wireless link to the target device, and the trigger event includes receiving a signal from a remote workstation terminal indicating that a screenshot image is requested from the application.

16. The system of claim 15, wherein the processor comprising, prior to sending the screenshot instruction, providing a version of the application to the target device, and authenticating the target device, wherein the image data received from the target device includes a screenshot of a page generated on the target device by the version of the application provided to the target device.

17. The system of claim 1, wherein the application has associated configuration data, and associating the image data with the application includes updating the configuration data to reference a filename for a file storing the image data.

18. A mobile electronic device, comprising:
a communications interface;
a display screen;
a storage having a version of an application stored thereon;
a processor configured for:
receiving through the communications interface a screenshot instruction indicating a desired orientation;
generating image data representing a screenshot of an image displayed on the display screen in the desired orientation; and
sending the image data through the communications interface.

19. The device of claim 18, wherein generating the image data comprises capturing screenshot of content generated on the display screen in the desired orientation.

20. The device of claim 18, wherein the screenshot instruction indicates a desired page of the application for viewing and generating the image data comprises capturing screenshot of content generated on the display screen of the desired page in the desired orientation.
